(19) United States
(12) Patent Application Publication
(10) Pub. No.: US 2025/0363504 A1
(43) Pub. Date: Nov. 27, 2025

(54) BLOCKCHAIN-BASED BLIND BOX MANAGEMENT METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Liang XU, Shenzhen (CN); Guohui ZHENG, Shenzhen (CN)

(21) Appl. No.: 19/292,434

(22) Filed: Aug. 6, 2025

Related U.S. Application Data
(63) Continuation of application No. PCT/CN2023/134776, filed on Nov. 28, 2023.

(30) Foreign Application Priority Data
Jul. 12, 2023 (CN) 202310859462.8

(51) Int. Cl. G06Q 30/018

(52) U.S. Cl. CPC G06Q 30/0185

(57) ABSTRACT

A blockchain-based blind box management method includes: receiving blind box generation information and corresponding item configuration information; verifying the blind box generation information and the item configuration information, and generating a block based on the blind box generation information and the item configuration information and storing the generated block in a blockchain in response to that the blind box generation information is determined to match the item configuration information; receiving blind box obtaining information; performing a verification of the blind box obtaining information based on the blind box generation information and blind box delivery information; and generating a block based on the blind box obtaining information and storing the generated block in the blockchain in response to that the verification of the blind box obtaining information succeeds.

### CROSS-REFERENCES TO RELATED APPLICATIONS

This application is a continuation of PCT Application No. PCT/CN2023/134776, filed on Nov. 28, 2023, which claims priority to Chinese Patent Application 202310859462.8, filed on Jul. 12, 2023 and entitled “BLOCKCHAIN-BASED BLIND BOX MANAGEMENT METHOD AND APPARATUS, DEVICE, AND STORAGE MEDIUM”, the entire contents of all of which are incorporated herein by reference.

### FIELD OF THE TECHNOLOGY

Embodiments of the present disclosure relate to the field of Internet technologies, and in particular, to a blockchain-based blind box management method and apparatus, a device, and a storage medium.

### BACKGROUND OF THE DISCLOSURE

A blind box is a commodity form, which is a box having a random attribute and including therein an item unknown to a user. Typically, merchants produce blind boxes, officially announce a probability of obtaining each item from the blind boxes, and releases the blind boxes into the market, so that users can purchase the blind boxes to obtain the items therein.

### SUMMARY

Embodiments of the present disclosure provide a blockchain-based blind box management method and apparatus, a device, and a storage medium, which can ensure fairness of blind box transactions. The technical solutions are as follows:

According to an aspect, a blockchain-based blind box management method is provided, including: receiving blind box generation information and corresponding item configuration information, the blind box generation information including a generated blind box identifier and item information associated with the blind box identifier, the item information associated with the blind box identifier indicating that a blind box corresponding to the blind box identifier is configured for packaging an item indicated by the item information, and the item configuration information including at least one of a release quantity of the item indicated by the item information or a proportion of the release quantity of the item to a release quantity of a plurality of items; verifying the blind box generation information and the item configuration information; generating a block based on the blind box generation information and the item configuration information and storing the generated block in a blockchain in response to that the blind box generation information is determined to match the item configuration information; receiving blind box obtaining information, the blind box obtaining information including a first object identifier and a first blind box identifier, the first blind box identifier indicating a blind box obtained by the first object identifier; and performing a verification of the blind box obtaining information based on the blind box generation information and blind box delivery information, the blind box delivery information indicating a blind box delivery status corresponding to the blind box generation information; and generating a block based on the blind box obtaining information and storing the generated block in the blockchain in response to that the verification of the blind box obtaining information succeeds.

According to another aspect, a blockchain-based blind box management apparatus is provided, which is arranged in a node device of a blockchain system and includes: a receiving module, configured to receive blind box generation information and corresponding item configuration information, the blind box generation information including a generated blind box identifier and item information associated with the blind box identifier, the item information associated with the blind box identifier indicating that a blind box corresponding to the blind box identifier is configured for packaging an item indicated by the item information, and the item configuration information including at least one of a release quantity of the item indicated by the item information or a proportion of the release quantity of the item to a release quantity of a plurality of items; and a storage module, configured to: verify the blind box generation information and the item configuration information; and generate a block based on the blind box generation information and the item configuration information and store the generated block in a blockchain in response to that the blind box generation information is determined to match the item configuration information, the receiving module being further configured to receive blind box obtaining information, the blind box obtaining information including a first object identifier and a first blind box identifier, the first blind box identifier indicating a blind box obtained by the first object identifier; and the storage module being further configured to: verify the blind box obtaining information based on the blind box generation information and blind box delivery information, the blind box delivery information indicating a blind box delivery status corresponding to the blind box generation information; and generate a block based on the blind box obtaining information and store the generated block in the blockchain in response to that the verification of the blind box obtaining information succeeds.

According to another aspect, a node device is provided, including a processor and a memory, the memory having at least one computer program stored therein, the at least one computer program being loaded and executed by the processor to implement the operations performed in the blockchain-based blind box management method as described in the above aspects.

According to another aspect, a non-transitory computer-readable storage medium is provided, having at least one computer program stored therein, the at least one computer program being loaded and executed by a processor to implement the operations performed in the blockchain-based blind box management method as described in the above aspects.

In the solutions provided in the embodiments of the present disclosure, due to the tamper-resistant characteristic of the blockchain, during blind box generation and blind box obtaining that is performed by an object, the blind box generation information and the corresponding item configuration information are stored in the blockchain, the blind box obtaining information is also stored in the blockchain, and the information is verified during storage of the information in the blockchain, which not only ensures that the stored blind box generation information matches the actual item configuration information, thereby ensuring accuracy of the information stored in the blockchain, but also enables tracing of flow of the released blind box based on the information stored in the blockchain, and facilitates determining whether the generated blind box and a release status thereof are consistent with the item configuration information, thereby preventing fraud of blind boxes and ensuring fairness of blind box transactions.

### BRIEF DESCRIPTION OF THE DRAWINGS

FIG. 1 is a schematic structural diagram of a blockchain system according to an embodiment of the present disclosure.

FIG. 2 is a schematic structural diagram of a blockchain according to an embodiment of the present disclosure.

FIG. 3 is a schematic structural diagram of an implementation environment according to an embodiment of the present disclosure.

FIG. 4 is a flowchart of a blockchain-based blind box management method according to an embodiment of the present disclosure.

FIG. 5 is a flowchart of another blockchain-based blind box management method according to an embodiment of the present disclosure.

FIG. 6 is a flowchart of another blockchain-based blind box management method according to an embodiment of the present disclosure.

FIG. 7 is a flowchart of another blockchain-based blind box management method according to an embodiment of the present disclosure.

FIG. 8 is a flowchart of identity verification performed through interaction between a first terminal and a server according to an embodiment of the present disclosure.

FIG. 9 is a flowchart of another blockchain-based blind box management method according to an embodiment of the present disclosure.

FIG. 10 is a flowchart of another blockchain-based blind box management method according to an embodiment of the present disclosure.

FIG. 11 is a flowchart of another blockchain-based blind box management method according to an embodiment of the present disclosure.

FIG. 12 is a schematic structural diagram of a social interaction-based blind box selling system according to an embodiment of the present disclosure.

FIG. 13 is a flowchart of another blockchain-based blind box management method according to an embodiment of the present disclosure.

FIG. 14 is a flowchart of another blockchain-based blind box management method according to an embodiment of the present disclosure.

FIG. 15 is a flowchart of another blockchain-based blind box management method according to an embodiment of the present disclosure.

FIG. 16 is a flowchart of another blockchain-based blind box management method according to an embodiment of the present disclosure.

FIG. 17 is a schematic structural diagram of a blockchain-based blind box management apparatus according to an embodiment of the present disclosure.

FIG. 18 is a schematic structural diagram of another blockchain-based blind box management apparatus according to an embodiment of the present disclosure.

FIG. 19 is a schematic structural diagram of a terminal according to an embodiment of the present disclosure.

FIG. 20 is a schematic structural diagram of a server according to an embodiment of the present disclosure.

### DESCRIPTION OF EMBODIMENTS

To make objectives, technical solutions, and advantages of embodiments of the present disclosure clearer, implementations of the present disclosure are described below in further detail with reference to drawings.

Terms “first”, “second”, and the like used in the present disclosure may be configured for describing various concepts in this specification. However, unless otherwise specified, these concepts are not limited by these terms. These terms are merely configured for distinguishing one concept from another. For example, without departing from the scope of the present disclosure, a first object identifier may be referred to as a second object identifier, and similarly, the second object identifier may be referred to as the first object identifier.

In terms “at least one”, “a plurality of”, “each”, and “any one” used in the present disclosure, “at least one” includes one, two, or more, “a plurality of” includes two or more, “each” refers to each of a plurality of corresponding items, and “any one” refers to any one of a plurality of items. For example, a plurality of blind box identifiers include three blind box identifiers. In this case, “each” refers to each blind box identifier of the three blind box identifiers, and “any one” refers to any one blind box identifier of the three blind box identifiers, which may be the first blind box identifier, the second blind box identifier, or the third blind box identifier.

All information (including but not limited to blind box generation information, item configuration information, and blind box obtaining information) and a blockchain involved in the present disclosure are authorized by a user or fully authorized by all parties, and collection, use, and processing of relevant data need to comply with relevant laws, regulations, and standards of relevant countries and regions. For example, the blind box generation information, the item configuration information, and the blind box obtaining information involved in the present disclosure are obtained under full authorization.

However, due to the current lack of a perfect management mechanism for blind boxes, merchants can arbitrarily modify the drawing probabilities of various items corresponding to blind boxes, resulting in inconsistency between drawing probabilities of various items and the officially announced drawing probabilities thereof, which undermines market fairness.

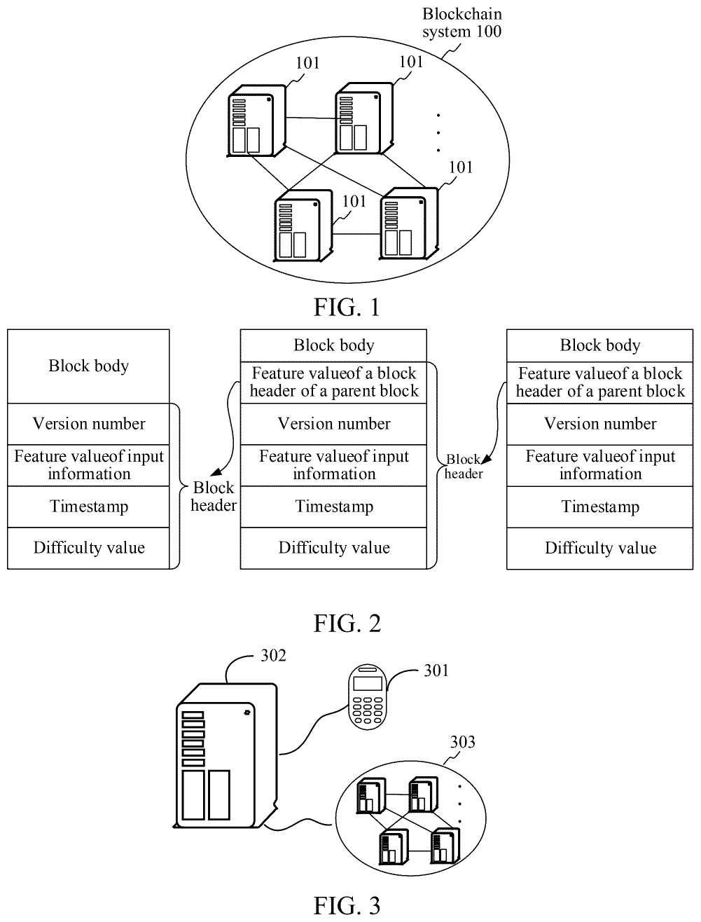

Refer to a blockchain system shown in FIG. 1. A blockchain system 100 refers to a system for data sharing between nodes. The blockchain system includes a plurality of node devices 101. Each node device 101 has an identical blockchain stored therein. The blockchain is formed by a plurality of blocks. As shown in FIG. 2, the blockchain is formed by a plurality of blocks. A genesis block includes a block header and a block body. The block header has an input information feature value, a version number, a timestamp, and a difficulty value stored therein, and the block body has input information stored therein. A next block of the genesis block uses the genesis block as a parent block, and the next block also includes a block header and a block body. The block header has an input information feature value of a current block, a block header feature value of the parent block, a version number, a timestamp, and a difficulty value stored therein, and so on. Therefore, block data stored in each block in the blockchain is associated with block data stored in the parent block, thereby ensuring the security of the input information in the blocks. During normal operation, each node device 101 can receive input information, and maintain the blockchain within the blockchain system based on the received input information. To ensure information exchange within the blockchain system, an information connection may exist between the node devices 101 in the blockchain system. Information may be transmitted between the node devices 101 through the information connection. For example, when any node device 101 in the blockchain system receives input information, the node device verifies the input information. After completing the verification, the node device may store the corresponding information and generate a block based on the information. Subsequently, the node device 101 respectively transmits the generated block to other node devices in the blockchain system in which the node device is located based on device identifiers of the other node devices in the blockchain system. The other node devices verify the generated block, and adds the generated block to blockchains stored therein after verifying the block, so that the blockchains stored in all of the node devices in the blockchain system are consistent.

The blockchain-based blind box management method provided in the embodiments of the present disclosure is performed by a node device in the blockchain system. The node device is a terminal or a server. In some embodiments, the server is an independent physical server, a server cluster or a distributed system composed of a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence (AI) platform. In some embodiments, the terminal is a smart phone, a tablet computer, a notebook computer, a desktop computer, a smart speaker, a smart watch, a smart voice interaction device, a smart household appliance, an on-board terminal, or the like, but is not limited thereto.

FIG. 3 is a schematic diagram of an implementation environment according to an embodiment of the present disclosure. Referring to FIG. 3, the implementation environment includes a terminal 301, a server 302, and a blockchain system 303. The terminal 301 and the server 302 are connected through a wireless or wired network, and the server 302 is connected to any node device in the blockchain system 303 through a wireless or wired network.

In a possible implementation, a blind box is provided as a virtual blind box. The server 302 is configured to provide a blind box service. The terminal 301 can interact with the server 302, so as to obtain a configured virtual blind box from the server 302 and redeem a virtual item included in the obtained virtual blind box. Additionally, the server 302 interacts with the node devices in the blockchain system 303 to store blind box generation information and item configuration information configured in the server 302 into the blockchain. Moreover, during the interaction between the terminal 301 and the server 302, the server 302 interacts with the node devices in the blockchain system 303 to store relevant information into the blockchain, for example, to store blind box obtaining information, blind box giving information, and redemption information into the blockchain.

In some embodiments, the terminal 301 has installed therein an application for which the server 302 provides services. The application may be any application. In some embodiments, the application is either a built-in application in an operating system of the terminal 301 or an application provided by a third-party. For example, the application is a blind box selling application, which has a function of selling blind boxes. Certainly, the blind box sale application may have other functions, such as a review function, a shopping function, a navigation function, and a gaming function. Through the application installed on the terminal 301, a user may interact with the server 302 to purchase released virtual blind boxes from the application.

In a possible implementation, a blind box is provided as a physical blind box, and the terminal 301 is a device configured to provide physical blind boxes. For example, the terminal 301 is a vending machine for physical blind boxes. The server 302 interacts with the node devices in the blockchain system 303 to store the blind box generation information and the item configuration information configured in the server 302 into the blockchain. Moreover, the user may obtain physical blind boxes from the terminal 301. The terminal 301 obtains blind box obtaining information and transmits the blind box obtaining information to the server 302. Moreover, the server 302 interacts with the node devices in the blockchain system 303 to store the blind box obtaining information into the blockchain.

Taking the terminal 301 as a vending machine for physical blind boxes as an example, an object may purchase physical blind boxes from the vending machine. During purchasing of a physical blind box, the object inputs an object identifier, so that the vending machine obtains both the object identifier and a blind box identifier corresponding to the physical blind box purchased by the object, generates blind box obtaining information, and transmits the blind box obtaining information to the server 302. The server 302 interacts with the node devices in the blockchain system 303 to store the blind box obtaining information in the blockchain.

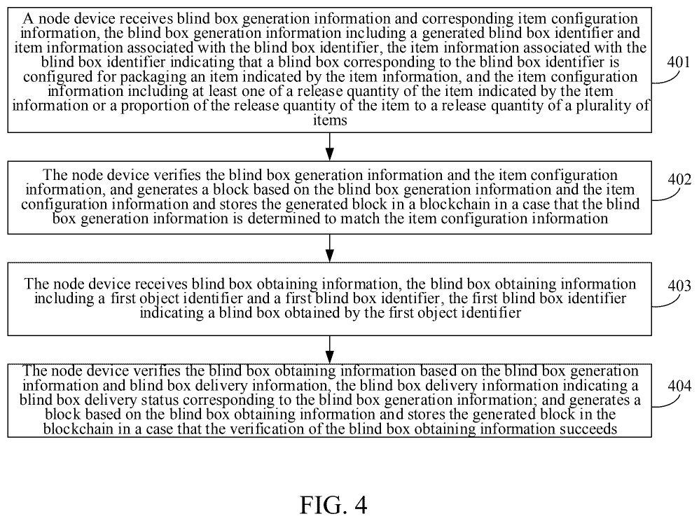

FIG. 4 is a flowchart of a blockchain-based blind box management method according to an embodiment of the present disclosure. The method is performed by a node device in a blockchain system. As shown in FIG. 4, the method including the following operations:

401: A node device receives blind box generation information and corresponding item configuration information, the blind box generation information including a generated blind box identifier and item information associated with the blind box identifier, the item information associated with the blind box identifier indicating that a blind box corresponding to the blind box identifier is configured for packaging an item indicated by the item information, and the item configuration information including at least one of a release quantity of the item indicated by the item information or a proportion of the release quantity of the item to a release quantity of a plurality of items.

In this embodiment of the present disclosure, a blind box is configured for packaging an item, and a user does not know an item included in a blind box when obtaining the blind box. During generation of blind boxes, item configuration information is pre-configured, which indicates a release quantity of each item or a proportion of each item in the to-be-generated blind boxes, to configure the blind boxes based on the item configuration information to ensure that the generated blind boxes match the configured item configuration information. Moreover, during release of the blind box, the item configuration information is officially announced in advance, so that the user knows a release quantity of each item or a proportion of each item in the generated blind boxes, and determines whether to obtain a blind box. A node device receives both the blind box generation information and the corresponding item configuration information, so as to subsequently verify the blind box generation information and the item configuration information, and store the information when determining that the blind box generation information matches the item configuration information, thereby achieving recording of a blind box generation status in the blockchain while ensuring accuracy of the stored information.

A blind box refers to a box including an item unknown before the box is opened. In other words, a blind box includes an item and the included item is unknown before the blind box is opened. A blind box may be a physical blind box or a virtual blind box. In response to that the blind box is a virtual blind box, the virtual blind box is configured for packaging a virtual item. In response to that the blind box is a physical blind box, the physical blind box is configured for packaging a physical item. The virtual item or the physical item may be an item of any type. For example, the virtual item may be a virtual card, a virtual pet, or another digital product, and the physical item is a figurine, a doll, or the like.

A blind box identifier is configured for representing a blind box, and may be represented in any form. For example, the blind box identifier may be represented in forms such as a character string or a number. Item information is configured for representing items to be packaged into blind boxes, and may be represented in any form. For example, the item information may be represented in a form of text. In some embodiments, the item information includes an item identifier, an item name, item introduction information, and the like. The blind box generation information is related information of a generated blind box, and can indicate a status of an item included in each generated blind box. Each piece of item information is configured for representing a type of item, and different item information represents different items.

The release quantity of the item information refers to a quantity of blind boxes including an item indicated by the item information in response to that a plurality of blind boxes are generated based on the item configuration information. The release quantity of the item information may be any quantity. For example, the release quantity is 10 or 2. A proportion of a release quantity of any item information to a release quantity of a plurality of pieces of item information refers to a proportion of blind boxes including the item indicated by the item information to a plurality of generated blind boxes in response to that a plurality of blind boxes are generated based on the item configuration information. For example, the proportion of the release quantity of any item information to the release quantity of the plurality of pieces of item information is 10% or 40%. The item configuration information is configuration information configured for generating blind boxes, indicating blind boxes that need to be generated and an item included in each blind box.

402: The node device verifies the blind box generation information and the item configuration information; and generates a block based on the blind box generation information and the item configuration information and stores the generated block in a blockchain in response to that the blind box generation information is determined to match the item configuration information.

In this embodiment of the present disclosure, the node device verifies the blind box generation information and the item configuration information, to determine whether the blind box generation information matches the item configuration information, that is, to determine whether the item included in each generated blind box is the same as an item included in each blind box indicated by the item configuration information, so as to determine whether the blind box generation information is generated based on the item configuration information, thereby ensuring accuracy of the blind box generation information. In response to that the blind box generation information matches the item configuration information, a block including the blind box generation information and the item configuration information is generated, and the generated block is stored in the blockchain, to achieve the storage of the blind box generation information and the item configuration information in the blockchain, and to ensure the accuracy of the data stored in the blockchain.

In a possible implementation, the process of generating a block based on the blind box generation information and the item configuration information includes: updating a hash tree configured for recording the blind box generation information and the item configuration information; and updating an update timestamp to a time at which the blind box generation information and the item configuration information are received, determining a random number, storing the random number in correspondence with the blind box generation information and the item configuration information, and generating the block.

403: The node device receives blind box obtaining information, the blind box obtaining information including a first object identifier and a first blind box identifier, the first blind box identifier indicating a blind box obtained by the first object identifier.

In this embodiment of the present disclosure, after blind boxes are released, an object may obtain a released blind box. When the object obtains the released blind box, blind box obtaining information is generated, which indicates a status of obtaining the released blind box by the object. The blind box obtaining information is stored in the blockchain by the node device, so that flow of the released blind box can be subsequently traced based on the information stored in the blockchain.

The first object identifier indicates the object who has obtained the blind box. The object may be any object, for example, may be a user or a company. The blind box corresponding to the first blind box identifier is the blind box obtained by the object indicated by the first object identifier.

404: The node device verifies the blind box obtaining information based on the blind box generation information and blind box delivery information, the blind box delivery information indicating a blind box delivery status corresponding to the blind box generation information; and generates a block based on the blind box obtaining information and stores the generated block in the blockchain in response to that the verification of the blind box obtaining information succeeds.

In this embodiment of the present disclosure, the blind box generation information indicates the item included in each generated blind box, and the blind box delivery information indicates the delivery status of each generated blind box. Therefore, the blind box obtaining information is verified based on the blind box generation information and the blind box delivery information, to determine whether the first blind box identifier in the blind box obtaining information is accurate, and whether the blind box indicated by the first blind box identifier has been delivered. In response to that the verification of the blind box obtaining information succeeds, a block including the blind box obtaining information is generated, and the generated block is stored in the blockchain, to achieve the storage of the blind box obtaining information in the blockchain and ensure the accuracy of the data stored in the blockchain.

In the solutions provided in this embodiment of the present disclosure, due to the tamper-resistant characteristic of the blockchain, during blind box generation and blind box obtaining that is performed by the object, the blind box generation information and the corresponding item configuration information are stored in the blockchain, the blind box obtaining information is also stored in the blockchain, and the information is verified during storage of the information in the blockchain, which not only ensures that the stored blind box generation information matches the actual item configuration information, thereby ensuring accuracy of the information stored in the blockchain, but also enables tracing of flow of the released blind box based on the information stored in the blockchain, and facilitates determining whether the generated blind box and a release status thereof are consistent with the item configuration information, thereby preventing fraud of blind boxes and ensuring fairness of blind box transactions.

Based on the embodiment shown in FIG. 4, in the embodiments of the present disclosure, the blind box obtaining information may alternatively be verified through verification of the blind box identifier included in blind box obtaining information. The specific process is detailed in the following embodiment.

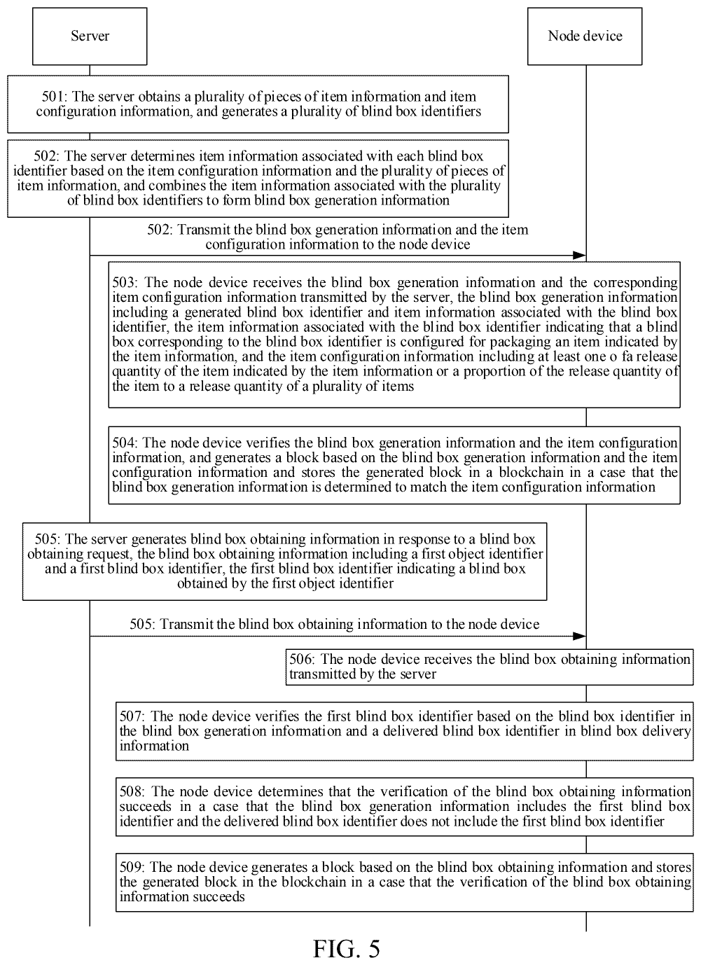

FIG. 5 is a flowchart of a blockchain-based blind box management method according to an embodiment of the present disclosure. The method may be performed by a server and any node device in a blockchain system. As shown in FIG. 5, the method includes the following operations:

501: The server obtains a plurality of pieces of item information and item configuration information, and generates a plurality of blind box identifiers.

The server is configured to provide blind box services, that is, the server serves as a blind box management server, and is configured to manage a generation status of blind boxes and flow of blind boxes. The plurality of pieces of item information indicates items to be packaged into blind boxes. To be specific, during generation of blind boxes based on the item configuration information, each generated blind box includes only one item, which is any one of the items indicated by the plurality of item information, and does not include another item. Each blind box identifier is configured for indicating one blind box, and a quantity of the plurality of generated blind box identifiers corresponds to a quantity of to-be-released blind boxes.

In this embodiment of the present disclosure, the server obtains a plurality of pieces of item information and item configuration information and generates a plurality of blind box identifiers, so as to subsequently determine associated item information for each blind box identifier based on the plurality of pieces of item information and the item configuration information.

In a possible implementation, the item configuration information further includes a quantity of blind boxes, which is a quantity of to-be-generated blind boxes. Operation 501 includes: receiving, by the server, a plurality of pieces of item information and item configuration information transmitted by a terminal, and generating, based on a blind box quantity in the item configuration information, blind box identifiers of the blind box quantity.

The terminal is configured to configure information. For example, the terminal is a terminal used by management personnel.

For example, the management personnel may configure a plurality of pieces of item information and item configuration information through the terminal. The plurality of pieces of item information indicates items the management personnel desire to package into blind boxes, and the item configuration information represents a proportion of a release quantity of each item to a release quantity of a plurality of items in blind boxes the management personnel desire to generate. The terminal transmits the plurality of pieces of item information and the item configuration information to the server, so that the server configures the blind boxes based on the plurality of pieces of item information and the item configuration information.

502: The server determines item information associated with each blind box identifier based on the item configuration information and the plurality of pieces of item information, combines the item information associated with the plurality of blind box identifiers to form blind box generation information, and transmits the blind box generation information and the item configuration information to a node device.

In this embodiment of the present disclosure, each blind box identifier indicates a to-be-generated blind box, and each blind box is configured to include an item indicated by one or more pieces of item information, the item configuration information indicating at least one of a release quantity of an item corresponding to each piece of item information or a proportion of the release quantity of the item corresponding to each piece of item information to a total release quantity of items corresponding to a plurality of pieces of item information. Thus, one or more associated pieces of item information are determined for each blind box identifier based on the item configuration information and the plurality of pieces of item information, to indicate that a blind box corresponding to each blind box identifier is configured to package an item corresponding to which item information, thereby ensuring that the item information associated with the plurality of blind box identifiers matches the item configuration information, that is, ensuring that a blind box identifier quantity associated with each piece of item information is equal to the release quantity of the item corresponding to the item information in the item configuration information, or ensuring that a proportion of the blind box identifier quantity associated with each piece of item information to a quantity of a plurality of pieces of item information is equal to a proportion of a release quantity of an item corresponding to the item information to a total release quantity of items corresponding to the plurality of pieces of item information in the item configuration information.

In response to that the item information associated with each blind box identifier is determined, the item information associated with a plurality of blind box identifiers is combined to form blind box generation information, so that the blind box generation information includes the plurality of generated blind box identifiers and the item information associated with each blind box identifier. The blind box generation information and the item configuration information are transmitted to the node device, so that the node device verifies the blind box generation information and the item configuration information and then store them on a blockchain.

In a possible implementation, the process of determining the item information associated with the blind box identifier includes: determining, for any one of the plurality of blind box identifiers, item information associated with the blind box identifier from the plurality of pieces of item information based on the item configuration information and item information associated with a third blind box identifier, the third blind box identifier being a blind box identifier for which associated item information has been determined.

In this embodiment of the present disclosure, since the item configuration information has indicated the release quantity of the plurality of pieces of item information or the proportion of the release quantity of the plurality of pieces of item information, during successive determining of associated item information for each blind box identifier, item information for a current blind box identifier is determined in combination with the item information associated with the third blind box identifier, to prevent the blind box identifier quantity associated with any item information from exceeding the release quantity of the item information in the item configuration information, or prevent the blind box identifier quantity associated with any item information from exceeding the proportion of the release quantity of the item information in the item configuration information, so as to ensure that the determined item information associated with the plurality of blind box identifiers matches the item configuration information, thereby ensuring accuracy of the determined item information.

The determined item information associated with the blind box identifier refers to the item information associated with the blind box identifier for which the item information has been determined during determining of the associated item information for each blind box identifier.

For example, each blind box identifier is associated with only one piece of item information. During determining of the item information associated with a first blind box identifier, one piece of item information is randomly determined from the plurality of pieces of item information as being associated with the first blind box identifier based on the item configuration information. During determining of the item information associated with a second blind box identifier, the item information associated with the second blind box identifier is determined from the plurality of pieces of item information based on the item configuration information and the item information associated with the first blind box identifier. During determining of the item information associated with a third blind box identifier, the item information associated with the third blind box identifier is determined from the plurality of pieces of item information based on the item configuration information, the item information associated with the first blind box identifier, and the item information associated with the second blind box identifier. The foregoing operation is repeated, until the associated item information for each blind box identifier is determined.

In a possible implementation, in response to that the blind boxes are virtual blind boxes, the server generates a plurality of virtual blind boxes based on the blind box generation information. Each virtual blind box corresponds to one blind box identifier, and the virtual blind box includes a virtual item, which corresponds to item information associated with the blind box identifier. Moreover, the plurality of virtual blind boxes are released, so that users can obtain the released virtual blind boxes. However, in response to that the blind boxes are physical blind boxes, a plurality of physical blind boxes are produced manually based on the blind box generation information. Each physical blind box corresponds to one blind box identifier, and the physical blind box includes a physical item, which corresponds to the item information associated with the blind box identifier. Moreover, the plurality of physical blind boxes are released, so that users can obtain the released physical blind boxes.

503: The node device receives the blind box generation information and the corresponding item configuration information transmitted by the server, the blind box generation information including a generated blind box identifier and item information associated with the blind box identifier, the item information associated with the blind box identifier indicating that a blind box corresponding to the blind box identifier is configured for packaging an item indicated by the item information, and the item configuration information including at least one of a release quantity of each piece of item information and a proportion of the release quantity of each piece of item information to a release quantity of the plurality of pieces of item information.

This embodiment of the present disclosure is described by using the example in which the server transmits the blind box generation information and the corresponding item configuration information to the node device. However, in another embodiment, operations 501-503 described above do not need to be performed, and instead, the node device receives the blind box generation information and the corresponding item configuration information in other manners.

504: The node device verifies the blind box generation information and the item configuration information; and generates a block based on the blind box generation information and the item configuration information and stores the generated block in a blockchain in response to that the blind box generation information is determined to match the item configuration information.

In a possible implementation, the process of verifying the blind box generation information and the item configuration information includes the following three manners.

First manner: In response to that the item configuration information includes a release quantity of each piece of item information, a quantity of each piece of item information in the blind box generation information and the release quantity of each piece of item information in the item configuration information are verified. In response to that the quantity of each piece of item information in the blind box generation information is equal to the release quantity of the item information in the item configuration information, the blind box generation information is determined to match the item configuration information. In response to that the quantity of any piece of item information in the blind box generation information is different from the release quantity of the item information in the item configuration information, the blind box generation information is determined not to match the item configuration information.

The quantity of any piece of item information in the blind box generation information refers to a total quantity of the item information associated with a plurality of blind box identifiers in the blind box generation information. For example, if the blind box generation information includes 10 blind box identifiers, and for target item information, the first blind box identifier is associated with one piece of target item information, the second blind box identifier is associated with two pieces of target item information, and the other eight blind box identifiers are not associated with the target item information in the blind box generation information, a quantity of the target item information in the blind box generation information is three.

In this embodiment of the present disclosure, the item configuration information has indicated the release quantity of each piece of item information, which is equivalent to indicating the release quantity of the item corresponding to each piece of item information, and the blind box generation information indicates the item information associated with the generated blind box identifier, so that the quantity of each piece of item information in the blind box generation information may be determined, and the quantity of the item information in the blind box generation information is compared with the release quantity of each piece of item information in the item configuration information, to determine whether the quantity of the item information in the blind box generation information is equal to the release quantity of the item information in the item configuration information, so as to determine whether the blind box generation information matches the item configuration information, thereby ensuring accuracy of the verification.

Second manner: In response to that the blind box configuration information includes the proportion of the release quantity of each piece of item information to the release quantity of the plurality of pieces of item information, a plurality of first proportions are determined based on the blind box generation information. The plurality of first proportions and the proportion included in the blind box configuration information, which is the proportion of the release quantity of each piece of item information to the release quantity of the plurality of pieces of item information, are verified. In response to that the first proportion corresponding to each piece of item information matches the proportion corresponding to the item information in the blind box configuration information, the blind box generation information is determined to match the item configuration information. In response to that the first proportion corresponding to any piece of item information is different from the proportion corresponding to the item information in the blind box configuration information, the blind box generation information is determined not to match the item configuration information.

The first proportion is configured for indicating the proportion of the quantity of any piece of item information in the blind box generation information to the quantity of the plurality of pieces of item information. Each proportion corresponds to one piece of item information, and different first proportions are configured for indicating the proportions of different pieces of item information to the item information included in the blind box generation information. In some embodiments, the process of determining the first proportion includes: determining the quantity of any piece of item information in the blind box generation information and the total quantity of the plurality of pieces of item information, and determining the proportion of the quantity of the item information to the total quantity as the first proportion.

In this embodiment of the present disclosure, the first proportion corresponding to each piece of item information is compared with the proportion corresponding to the item information in the blind box configuration information, to determine whether the first proportion corresponding to each piece of item information in the blind box generation information matches the proportion corresponding to the item information in the item configuration information, so as to determine whether the blind box generation information matches the item configuration information, thereby ensuring the accuracy of the verification.

Third manner: In response to that the blind box configuration information includes both the release quantity of each piece of item information and the proportion of the release quantity of each piece of item information to the release quantity of the plurality of pieces of item information, the quantity of each piece of item information in the blind box generation information and the release quantity of each piece of item information in the item configuration information are verified.

The plurality of first proportions are determined based on the blind box generation information, and the plurality of first ratios and the proportion of the release quantity of each piece of item information to the release quantity of the plurality of pieces of item information in the blind box configuration information are verified. In response to that the quantity of each piece of item information in the blind box generation information is equal to the release quantity of the item information in the item configuration information and that the first proportion corresponding to each piece of item information is equal to the proportion corresponding to the item information in the blind box configuration information, the blind box generation information is determined to match the item configuration information. In response to that the quantity of any piece of item information in the blind box generation information is different from the release quantity of the item information in the item configuration information or that the first proportion corresponding to any piece of item information is different from the proportion corresponding to the item information in the blind box configuration information, the blind box generation information is determined not to match the item configuration information.

The operation is the same as those in the first manner and the second manner described above, which is not described in detail herein.

505: The server generates blind box obtaining information in response to a blind box obtaining request, the blind box obtaining information including a first object identifier and a first blind box identifier, the first blind box identifier indicating a blind box obtained by the first object identifier, and transmits the blind box obtaining information to the node device.

The blind box obtaining request indicates that the first object identifier requests to obtain a blind box. In this embodiment of the present disclosure, the server generates the blind box obtaining information in response to the blind box obtaining request, to indicate that the first object identifier obtains the blind box corresponding to the first blind box identifier, and transmits the blind box obtaining information to the node device, so that the node device stores the blind box obtaining information in the blockchain.

In a possible implementation, when the blind box obtaining request is transmitted by the terminal and the blind box obtaining request carries the first object identifier and the first blind box identifier, the server may generate the blind box obtaining information based on the first object identifier and the first blind box identifier carried in the blind box obtaining request.

In this embodiment of the present disclosure, the blind box may be a physical blind box or a virtual blind box. In response to that the blind box is a physical blind box, the terminal is a device configured to provide physical blind boxes. In response to that the blind box is a virtual blind box, the terminal is any terminal used by an object.

For example, in response to that the blind box is a physical blind box, taking the terminal as a vending machine for physical blind boxes as an example, an object may input an object identifier in the vending machine, and then purchase a physical blind box from the vending machine. During physical blind box purchasing, the object may select any physical blind box, or the vending machine may randomly select any physical blind box. Then the vending machine can obtain an object identifier and a blind box identifier corresponding to the selected physical blind box, and transmit a blind box obtaining request which carries the object identifier and the blind box identifier to the server.

As another example, in response to that the blind box is a virtual blind box, the terminal may display a plurality of virtual blind boxes that have been released by the server. When the object selects any virtual blind box through the terminal, the terminal can obtain a blind box identifier corresponding to the selected virtual blind box, and a blind box obtaining request which carries the object identifier and the blind box identifier is transmitted to the server through the terminal.

In some embodiments, the process of generating the blind box obtaining information includes: combing the first object identifier serving as an obtaining party and the first blind box identifier in the blind box obtaining request to form the blind box obtaining information.

In a possible implementation, when the blind box obtaining request is transmitted by the terminal, the blind box is a virtual blind box, and the blind box obtaining request carries only the first object identifier, the process of generating the blind box obtaining information by the server includes: determining, by the server, any virtual blind box from the released virtual blind boxes for the first object identifier in response to the blind box obtaining request, and generating blind box obtaining information based on the first blind box identifier and the first object identifier, the first blind box identifier indicating the virtual blind box determined for the first object identifier.

For example, the object may randomly draw a virtual blind box from the server through the terminal. The server determines any virtual blind box for the first object identifier in response to the blind box obtaining request, the first blind box identifier indicating the virtual blind box determined for the first object identifier, and then may generate blind box obtaining information for subsequent storage in the blockchain.

In some embodiments, the process of the generating the blind box obtaining information by the server includes: determining, by the server, any virtual blind box from current remaining released virtual blind boxes for the first object identifier in response to the blind box obtaining request, and generating blind box obtaining information based on the first blind box identifier and the first object identifier, the first blind box identifier indicating the virtual blind box determined for the first object identifier.

In this embodiment of the present disclosure, during virtual blind box obtaining that is performed by the object, a virtual blind box is determined from the current remaining virtual blind boxes for the object, to ensure that a delivered virtual blind box matches the released virtual blind box, and prevent repeated obtaining of any virtual blind box, thereby ensuring accuracy of the delivery of the virtual blind boxes.

506: The node device receives the blind box obtaining information transmitted by the server.

This embodiment of the present disclosure is described by using the example in which the server transmits the blind box generation information and the corresponding item configuration information to the node device. However, in another embodiment, operations 505-506 described above do not need to be performed, and instead, the node device receives the blind box obtaining information in other manners.

507: The node device verifies the first blind box identifier based on the blind box identifier in the blind box generation information and a delivered blind box identifier in blind box delivery information.

In this embodiment of the present disclosure, the blind box delivery information indicates the delivery status of the blind box corresponding to the blind box generation information. The blind box delivery information includes the delivered blind box identifier, which corresponds to blind box that has been obtained by the object. Since the blind box identifier in the blind box generation information indicates the released blind box, the first blind box identifier is verified in combination with the delivered blind box identifier to determine whether the first blind box identifier is included in the blind box generation information and whether the first blind box identifier is a delivered blind box identifier, so as to prevent fraud of the first blind box identifier and repeated delivery of the first blind box identifier, thereby ensuring the accuracy of the verification.

In this embodiment of the present disclosure, the first blind box identifier is verified based on the blind box identifier in the blind box generation information and the delivered blind box identifier. However, in another embodiment, operation 507 described above does not need to be performed, and the blind box obtaining information is verified based on the blind box generation information and the blind box delivery information.

508: The node device determines that the verification of the blind box obtaining information succeeds in response to that the blind box generation information includes the first blind box identifier and the delivered blind box identifier does not include the first blind box identifier.

In this embodiment of the present disclosure, in response to that the blind box generation information includes the first blind box identifier and the delivered blind box identifier does not include the first blind box identifier, it indicates that the first blind box identifier is a blind box identifier corresponding to a released blind box, and the blind box corresponding to the first blind box identifier has not been delivered, to prevent fraud of the first blind box identifier and repeated delivery of the blind box corresponding to the first blind box identifier, thereby ensuring the accuracy of the verification.

In this embodiment, when the blind box generation information includes the first blind box identifier and the delivered blind box identifiers does not include the first blind box identifier, it indicates that the verification of the blind box obtaining information succeeds. However, in another embodiment, operation 508 described above does not need to be performed, and it is determined whether the verification of the blind box obtaining information succeeds in another manner.

509: The node device generates a block based on the blind box obtaining information and stores the generated block in the blockchain in response to that the verification of the blind box obtaining information succeeds.

The process of generating the block based on the blind box obtaining information is the same as the process of generating the block based on the blind box generation information and the item configuration information described above, which is not described in detail herein.

In the solutions provided in this embodiment of the present disclosure, due to the tamper-resistant characteristic of the blockchain, during blind box generation and blind box obtaining that is performed by the object, the blind box generation information and the corresponding item configuration information are stored in the blockchain, the blind box obtaining information is also stored in the blockchain, and the blind box obtaining information is verified during storage of the blind box obtaining information in the blockchain, which not only ensures that the stored blind box generation information matches the actual item configuration information, thereby ensuring accuracy of the information stored in the blockchain, but also enables tracing of flow of the released blind box based on the information stored in the blockchain, and facilitates determining whether the generated blind box and a release status thereof are consistent with the item configuration information, thereby preventing fraud of blind boxes and ensuring fairness of blind box transactions.

Moreover, since the blind box identifier in the blind box generation information corresponds to the released blind box, the first blind box identifier is verified in combination with the delivered blind box identifier to determine whether the first blind box identifier is included in the blind box generation information and whether the first blind box identifier is a delivered blind box identifier. In response to that the blind box generation information includes the first blind box identifier and the delivered blind box identifier does not include the first blind box identifier, it indicates the first blind box identifier is a blind box identifier corresponding to a released blind box, and the blind box corresponding to the first blind box identifier has not been delivered, to prevent fraud of the first blind box identifier and repeated delivery of the blind box corresponding to the first blind box identifier, thereby ensuring the accuracy of the verification.

In the embodiment shown in FIG. 5 described above, when the server performs operation 505 described above, the first object identifier has obtained the blind box corresponding to the first blind box identifier. However, in another embodiment, when the server performs operation 505 described above, the server has not delivered the virtual blind box indicated by the first blind box identifier to the first object identifier, and the server delivers the blind box corresponding to the first blind box identifier to the first object identifier only after the node device successfully stores the blind box obtaining information in the blockchain. To be specific, the process of delivering, by the server, the virtual blind box indicated by the first blind box identifier to the first object identifier includes: After the node device generates the block based on the blind box obtaining information and stores the generated block in the blockchain, the node device generates a first storage success notification, which indicates that the blind box obtaining information has been successfully stored in the blockchain, and transmits the first storage success notification to the server. In response to that the server receives the first storage success notification is received by the server, the server delivers the blind box corresponding to the first blind box identifier to the first object identifier.

Additionally, during delivery of the blind box corresponding to the first blind box identifier to the first object identifier, in response to that the blind box is a virtual blind box, the server delivers the virtual blind box indicated by the first blind box identifier to a terminal logged by the first object identifier. In response to that the blind box is a physical blind box, the server transmits a delivery command to the terminal, and the terminal releases the physical blind box indicated by the first blind box identifier from the terminal in response to the delivery command, so that the object takes the physical blind box.

The embodiment shown in FIG. 5 described above is described by using the example in which the verification of the blind box obtaining information succeeds. However, in another embodiment, the verification of the blind box obtaining information may fail. In this case, after operation 507, the method further includes: determining that the verification of the blind box obtaining information fails in response to that the blind box generation information does not include the first blind box identifier or in response to that the delivered blind box identifier includes the first blind box identifier; and transmitting a first failure notification to the server in response to that the verification of the blind box obtaining information fails, the first failure notification indicating that the verification of the blind box obtaining information fails verification, so that the server stops delivering the blind box corresponding to the first blind box identifier to the first object identifier based on the first failure notification.

In this embodiment of the present disclosure, the blind box generation information not including the first blind box identifier indicates that the first blind box identifier is a fake blind box identifier, and the delivered blind box identifier including the first blind box identifier indicates that the blind box corresponding to the first blind box identifier has already been delivered. Therefore, in either a case that the blind box generation information does not include the first blind box identifier or a case that the delivered blind box identifier includes the first blind box identifier, it indicates that the blind box obtaining information is inaccurate. In this case, the blind box obtaining information is not stored, and the server is notified to stop delivering the blind box corresponding to the first blind box identifier, thereby ensuring security of blind box delivery.

Based on the embodiments shown in FIG. 4 and FIG. 5 described above, in the embodiments of the present disclosure, in response to that an object obtains a blind box, the blind box of the object may be given to another object, and blind box giving information is stored in the blockchain. The specific process is detailed in the following embodiment.

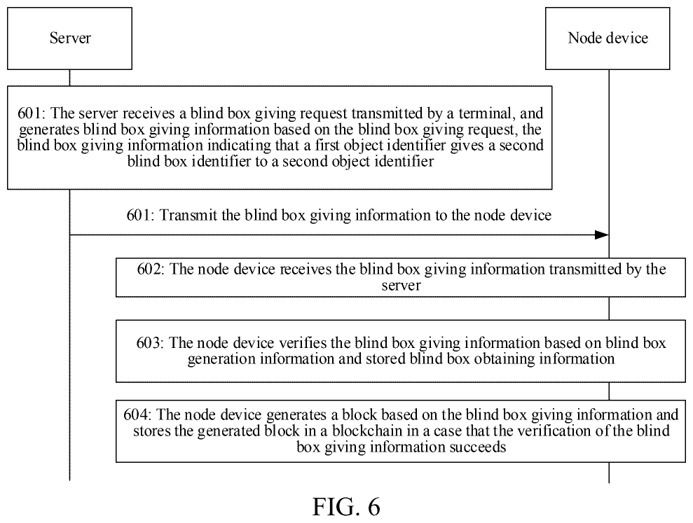

FIG. 6 is a flowchart of a blockchain-based blind box management method according to an embodiment of the present disclosure. The method may be performed by a server and any node device in a blockchain system. As shown in FIG. 6, the method includes the following operations:

601: A server receives a blind box giving request transmitted by a terminal, generates blind box giving information based on the blind box giving request, the blind box giving information indicating that a first object identifier gives a second blind box identifier to a second object identifier, and transmits the blind box giving information to a node device.

The blind box giving request indicates that a giving party gives a blind box to a receiving party, and the blind box giving request carries the first object identifier as the giving party, the second object identifier as the receiving party, and the second blind box identifier. In this embodiment of the present disclosure, the second blind box identifier may be any blind box identifier, which may be a blind box identifier the same as the first blind box identifier in the foregoing embodiments, or may be a blind box identifier different from the first blind box identifier.

For example, when an object indicated by the first object identifier purchases any blind box through a terminal and obtains the blind box identifier corresponding to the blind box, it means the object owns the blind box, that is, the object owns the blind box identifier corresponding to the blind box. Moreover, the object may trigger a giving operation for the blind box identifier through the terminal and select the second object identifier as the receiving party, so as to give the blind box identifier to an object indicated by the second object identifier. The terminal transmits the blind box giving request to the server in response to the giving operation.

In a possible implementation, the generating blind box giving information based on the blind box giving request includes: combing the first object identifier as the giving party, the second object identifier as the receiving party, and the second blind box identifier in the blind box giving request to form the blind box giving information.

602: The node device receives the blind box giving information transmitted by the server.

This embodiment of the present disclosure is described by using the example in which the server transmits the blind box giving information to the node device. However, in another embodiment, operations 601-602 described above do not need to be performed, and the node device receives the transmitted blind box giving information in another manner.

603: The node device verifies the blind box giving information based on blind box generation information and stored blind box obtaining information.

In this embodiment of the present disclosure, since the blind box identifier included in the blind box generation information in a blockchain corresponds to a released blind box, and the blind box obtaining information stored in the blockchain can indicate an owner of a delivered blind box identifier, that is, an object identifier included in any blind box obtaining information is an owner of a blind box identifier included in the blind box obtaining information, the node device verifies the blind box giving information based on the blind box generation information and the blind box obtaining information in the blockchain, to determine whether the second blind box identifier is the blind box identifier included in the blind box generation information, whether the first object identifier owns the second blind box identifier, and the like, so as to prevent fraud of the second blind box identifier and prevent the first object identifier from giving a second blind box identifier owned by another object identifier to the second object identifier, thereby ensuring accuracy of subsequent giving.

In a possible implementation, operation 603 includes: verifying the second blind box identifier based on the blind box identifier in the blind box generation information; and querying the stored blind box obtaining information for blind box obtaining information including the first object identifier and the second blind box identifier.

In this embodiment of the present disclosure, it is determined whether the second blind box identifier is the blind box identifier included in the blind box generation information, and the blockchain is obtained through query for the blind box obtaining information including the first object identifier and the second blind box identifier to determine whether the first object identifier owns the second blind box identifier, to prevent fraud of the second blind box identifier and prevent the first object identifier without the second blind box identifier from giving the second blind box identifier, thereby ensuring the accuracy of the verification and ensuring the accuracy of subsequent blind box giving.

In some embodiments, a manner of determining whether the verification of the blind box giving information succeeds includes: determining that the verification of the blind box giving information succeeds in response to that the blind box generation information includes the second blind box identifier and the blind box obtaining information including the first object identifier and the second blind box identifier is obtained through query; and determining that the verification of the blind box giving information fails in response to that the blind box generation information does not include the second blind box identifier or in response to that the blind box obtaining information including the first object identifier and the second blind box identifier is not obtained through query.

In this embodiment of the present disclosure, in response to that the blind box generation information includes the second blind box identifier and the blind box obtaining information including the first object identifier and the second blind box identifier is obtained through query, it indicates that the second blind box identifier is the blind box identifier corresponding to the released blind box and that the first object identifier owns the second blind box identifier, which indicates that the first object identifier can give the second blind box identifier to another object identifier. Therefore, it is determined that the verification of the blind box giving information succeeds. In response to that the blind box generation information does not include the second blind box identifier, it indicates that the second blind box identifier is not the blind box identifier corresponding to the released blind box, that is, the second blind box identifier is a fake blind box identifier. In response to that the blind box obtaining information including the first object identifier and the second blind box identifier is not obtained through query, it indicates that the first object identifier does not own the second blind box identifier, which indicates that the first object identifier cannot give the second blind box identifier to another object identifier. Therefore, it is determined that the verification of the blind box giving information fails.

In this embodiment of the present disclosure, it is determined whether the verification of the blind box giving information succeeds depending on whether the blind box generation information includes the second blind box identifier and whether the blind box obtaining information including the first object identifier and the second blind box identifier is obtained through query, to prevent fraud of the second blind box identifier and prevent the first object identifier without the second blind box identifier from giving the second blind box identifier, thereby ensuring the accuracy of the verification and the accuracy of subsequent blind box giving.

604: The node device generates a block based on the blind box giving information and stores the generated block in a blockchain in response to that the verification of the blind box giving information succeeds.

The process of generating the block based on the blind box giving information is the same as the process of generating the block based on the blind box generation information and the item configuration information described above, which is not described in detail herein.

In the solution provided in this embodiment of the present disclosure, in the process in which the object gives the owned blind box, the node device verifies the blind box giving information which is configured for indicating a status of giving the blind box by the object. In response to that the verification of the blind box giving information succeeds, the block including the blind box giving information is generated, and the generated block is stored in the blockchain, to achieve storage of the blind box giving information in the blockchain and ensure accuracy of the data stored in the blockchain. Moreover, flow of released blind box may be traced based on the information stored in the blockchain, which can prevent fraud of blind boxes and ensure fairness of blind box transactions.

The embodiment shown in FIG. 6 is described by using the example in which the verification of the blind box giving information succeeds. However, in another embodiment, the verification of the blind box giving information may fail. For example, in response to that the server has not transferred the second object identifier to the first object identifier when the server transmits the blind box giving information to the node device, the server transfers the second object identifier to the first object identifier only after the node device successfully stores the blind box giving information in the blockchain. In this case, after operation 603, the method further includes: transmitting a second failure notification to the server in response to that the verification of the blind box giving information fails, the second failure notification indicating that the verification of the blind box giving information fails, so that the server stops transferring the second object identifier to the first object identifier based on the second failure notification.

In this embodiment of the present disclosure, in response to that the verification of the blind box giving information fails, it indicates that the first object identifier cannot give the second blind box identifier to the second object identifier. In this case, the server is notified to stop transferring the second object identifier to the first object identifier, to prevent mistaken giving, thereby ensuring security of blind box giving.

Based on the embodiments shown in FIG. 4 and FIG. 5 described above, in the embodiments of the present disclosure, the object can redeem the owned virtual blind box to obtain the virtual item included in the virtual blind box, and redemption information is stored in the blockchain. The specific process is detailed in the following embodiment.

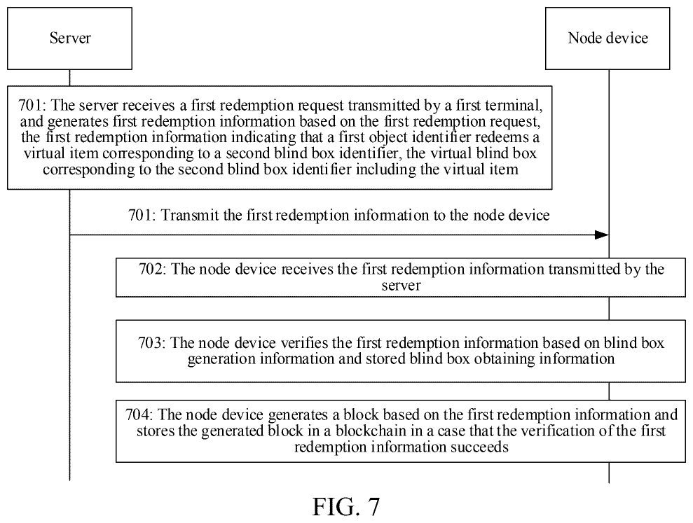

FIG. 7 is a flowchart of a blockchain-based blind box management method according to an embodiment of the present disclosure. The method may be performed by a server and any node device in a blockchain system. As shown in FIG. 7, the method includes the following operations:

701: A server receives a first redemption request transmitted by a first terminal, generates first redemption information based on the first redemption request, the first redemption information indicating that a first object identifier redeems a virtual item corresponding to a second blind box identifier, the virtual blind box corresponding to the second blind box identifier including the virtual item, and transmits the first redemption information to a node device.

The first redemption request indicates that the first object identifier requests to redeem the virtual item corresponding to the second blind box identifier, and the first redemption request carries the first object identifier and the second blind box identifier. The first terminal is a terminal logged by the first object identifier. In this embodiment of the present disclosure, an object indicated by the first object identifier can initiate a redemption process for the second blind box identifier owned by the object through the terminal.

For example, after the object indicated by the first object identifier purchases any virtual blind box through a first terminal, the object may redeem the purchased virtual blind box through the first terminal to obtain a virtual item included in the virtual blind box. The object may trigger a redemption operation for the owned blind box identifier through the first terminal to redeem the virtual item corresponding to the blind box identifier, the virtual blind box corresponding to the blind box identifier including the virtual item corresponding to the blind box identifier. The first terminal transmits the first redemption request to the server in response to the redemption operation.

In a possible implementation, the generating first redemption information based on the first redemption request includes: combining the first object identifier and the second blind box identifier in the first redemption request to form the first redemption information.

In a possible implementation, if the server has blind box generation information and blind box obtaining information stored therein, the process of generating the first redemption information includes: verifying, by the server, the first object identifier and the second blind box identifier carried in the first redemption request based on the stored blind box generation information and blind box obtaining information, and generating the first redemption information based on the first redemption request in response to that the verification succeeds.

In this embodiment of the present disclosure, after receiving the first redemption request, the server performs the verification based on the stored blind box generation information and blind box obtaining information, and generates the first redemption information and transmits the first redemption information to the node device in response to that the verification succeeds, to prevent the server from transmitting the first redemption information to the node device in response to that the first object identifier does not own the second blind box identifier or the second blind box identifier is a fake identifier, thereby saving network resources.

The process of verifying the first object identifier and the second blind box identifier carried in the first redemption request by the server is the same as operation 703 described below.

In a possible implementation, before generating the first redemption information, the server further performs identity verification. To be specific, the process of generating the first redemption information includes: transmitting, by the server, an identity verification notification to the first terminal in response to the first redemption request; obtaining, by the first terminal, identity verification information and transmitting the identity verification information to the server based on the identity verification notification; and generating, by the server, the first redemption information based on the first redemption request in response to that verification of the identity verification information succeeds.

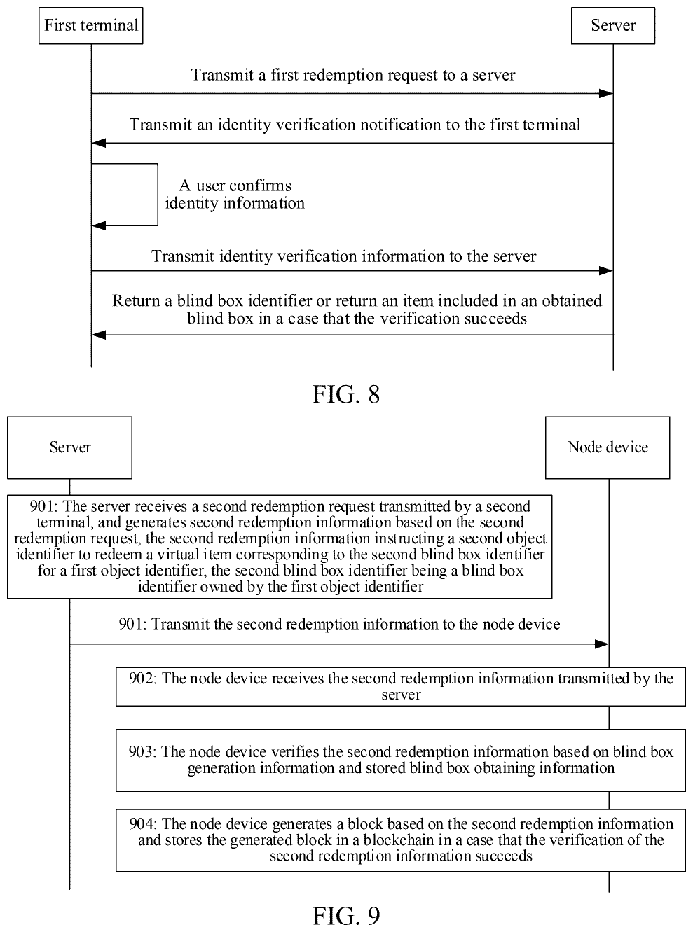

In this embodiment of the present disclosure, before generating the first redemption information, the server performs identity verification to ensure that the first redemption request is initiated by the object indicated by the first object identifier through the first terminal, thereby ensuring security of blind box redemption. For example, the process of identity verification interaction between the first terminal and the server is shown in FIG. 8. Additionally, in response to that the verification of the identity verification information fails, the server retransmits the identity verification notification to the first terminal to re-initiate the identity verification process.

702: The node device receives the first redemption information transmitted by the server.

This embodiment of the present disclosure is described by using the example in which the server transmits the first redemption information to the node device. However, in another embodiment, operations 701-702 described above do not need to be performed, and the node device receives the transmitted first redemption information in another manner.

703: The node device verifies the first redemption information based on the blind box generation information and stored blind box obtaining information.

In this embodiment of the present disclosure, since the blind box identifier in the blind box generation information in a blockchain is a blind box identifier corresponding to a released blind box, and the blind box obtaining information stored in the blockchain can indicate an owner of a delivered blind box identifier, that is, an object identifier included in any blind box obtaining information is an owner of a blind box identifier included in the blind box obtaining information, the node device verifies the first redemption information based on the blind box generation information and the blind box obtaining information in the blockchain, to determine whether the second blind box identifier is a blind box identifier included in the blind box generation information, whether the first object identifier owns the second blind box identifier, and the like, so as to prevent fraud of the second blind box identifier and prevent the first object identifier from redeeming an unowned second blind box identifier, so that the object can only redeem a blind box corresponding to owned blind box identifier, thereby ensuring accuracy of subsequent blind box redemption.

In a possible implementation, operation 703 includes: verifying the second blind box identifier based on the blind box identifier in the blind box generation information; and querying the stored blind box obtaining information for blind box obtaining information including the first object identifier and the second blind box identifier; and verify the virtual item based on item information associated with the second blind box identifier in the blind box generation information in response to that the blind box generation information includes the second blind box identifier.

In this embodiment of the present disclosure, the second blind box identifier is verified based on the blind box identifier in the blind box generation information, to determine whether the second blind box identifier is a blind box identifier included in the blind box generation information. The blockchain is queried for the blind box obtaining information including the first object identifier and the second blind box identifier to determine whether the first object identifier owns the second blind box identifier. Moreover, in response to that the blind box generation information includes the second blind box identifier, the virtual item is further verified based on the item information associated with the second blind box identifier in the blind box generation information, to determine whether the virtual item indicated by the first redemption request is accurate, that is, determine whether the virtual item to be delivered to the first object identifier is accurate.

In this embodiment of the present disclosure, verification is performed to determine whether the second blind box identifier is a blind box identifier included in the blind box generation information, whether the first object identifier owns the second blind box identifier, and whether the virtual item to be delivered to the first object identifier is sufficiently accurate, so as to prevent fraud of the second blind box identifier and prevent the first object identifier without the second blind box identifier from redeeming the second blind box identifier, thereby ensuring accuracy of the verification and accuracy of subsequent blind box redemption.

In some embodiments, a manner of determining whether the verification of the first redemption information succeeds includes: determining that the verification of the first redemption information succeeds in response to that the blind box generation information includes the second blind box identifier, the blind box obtaining information including the first object identifier and the second blind box identifier is obtained through query, and the item information associated with the second blind box identifier matches the virtual item; and determining that the verification of the first redemption information fails in response to that the blind box generation information does not include the second blind box identifier, or in response to that the blind box obtaining information including the first object identifier and the second blind box identifier is not obtained through query, or in response to that the item information associated with the second blind box identifier does not match the virtual item.

In this embodiment of the present disclosure, in response to that the blind box generation information includes the second blind box identifier, the blind box obtaining information including the first object identifier and the second blind box identifier is obtained through query, and the item information associated with the second blind box identifier matches the virtual item, it indicates that the second blind box identifier is the blind box identifier corresponding to the released blind box, the first object identifier owns the second blind box identifier, and the virtual item to be delivered to the first object identifier is accurate, which indicates that the first object identifier can redeem the second blind box identifier and the virtual item corresponding to the second blind box identifier can be delivered to the first object identifier. Therefore, it is determined that the verification of the first redemption information succeeds.

In response to that the blind box generation information does not include the second blind box identifier, it indicates that the second blind box identifier is not the blind box identifier corresponding to the released blind box, that is, the second blind box identifier is a fake blind box identifier. In response to that the blind box obtaining information including both the first object identifier and the second blind box identifier is not obtained through query, it indicates that the first object identifier does not own the second blind box identifier, which indicates that the first object identifier cannot redeem the virtual item corresponding to the second blind box identifier. In response to that the item information associated with the second blind box identifier does not match the virtual item, it indicates that the virtual item which is to be indicated to the first redemption information by the server is inaccurate. Therefore, it is determined the verification of the first redemption information fails.

In this embodiment of the present disclosure, it is determined whether the verification of the first redemption information succeeds depending on whether the blind box generation information includes the second blind box identifier and whether the blind box obtaining information including the first object identifier and the second blind box identifier is obtained through query, to prevent fraud of the second blind box identifier and prevent the first object identifier without the second blind box identifier from redeeming the virtual item corresponding to the second blind box identifier, thereby ensuring accuracy of the verification and accuracy of subsequent blind box redemptions.

704: The node device generates a block based on the first redemption information and stores the generated block in a blockchain in response to that the verification of the first redemption information succeeds.

The process of generating the block based on the first redemption information is the same as the process of generating the block based on the blind box generation information and the item configuration information described above, which is not described in detail herein.

In the solution provided in this embodiment of the present disclosure, in the process in which the object redeems the owned blind box, the node device verifies the first redemption information which is configured for indicating a status of redeeming the blind box by the object. In response to that the verification of the first redemption information succeeds, the block including the first redemption information is generated, and the generated block is stored in the blockchain, to achieve storage of the first redemption information in the blockchain and ensure accuracy of the data stored in the blockchain. Moreover, a redemption status of the released blind box may be traced based on the information stored in the blockchain, which can prevent fraud of blind boxes and ensure fairness of blind box transactions.

Based on the embodiment shown in FIG. 7 described above, the server has not delivered the virtual blind box corresponding to the second blind box identifier to the first object identifier when performing operation 701, and delivers the virtual blind box corresponding to the second blind box identifier to the first object identifier only in response to that the node device successfully stores the first redemption information in the blockchain. To be specific, the process in which the server delivers the virtual blind box indicated by the first blind box identifier to the first object identifier includes: generating a second storage success notification after the node device generates the block based on the first redemption information and stores the generated block in the blockchain, the second storage success notification indicating that the first redemption information has been successfully stored in the blockchain; transmitting the second storage success notification to the server; and delivering, by the server, the blind box corresponding to the first blind box identifier to the first object identifier based on the first redemption information in response to that the server receives the second storage success notification.

In this embodiment of the present disclosure, the server receiving the second storage success notification indicates that the verification of the first redemption information by the node device succeeds. Therefore, the server delivers the blind box corresponding to the first blind box identifier to the first object identifier based on the first redemption information, to ensure accuracy of blind box delivery.

The embodiment shown in FIG. 7 described above is described by using the example in which the verification of the blind box giving information succeeds. However, in another embodiment, the verification of the blind box giving information may fail. In this case, after operation 703, the method further includes: transmitting a third failure notification to the server in response to that the verification of the first redemption information fails, the third failure notification indicating that verification of the first redemption information fails, so that the server stops redeeming the virtual item corresponding to the second blind box identifier for the first object identifier based on the third failure notification, the virtual item being included in the virtual blind box corresponding to the second blind box identifier.

In this embodiment of the present disclosure, in response to that the verification of the first redemption information fails, it indicates that the virtual item corresponding to the second blind box identifier cannot be redeemed for the first object identifier. Therefore, the server is notified to stop redeeming the virtual item corresponding to the second blind box identifier for the first object identifier, to prevent mistaken redemption, thereby ensuring security of blind box redemption.

Based on the embodiments shown in FIG. 4 and FIG. 5 described above, in the embodiments of the present disclosure, an object can consign another object to redeem a blind box for the object, and redemption information is stored in the blockchain. The specific process is detailed in the following embodiment.

FIG. 9 is a flowchart of a blockchain-based blind box management method according to an embodiment of the present disclosure. The method may be performed by a server and any node device in a blockchain system. As shown in FIG. 9, the method includes the following operations:

901: A server receives a second redemption request transmitted by a second terminal, generates second redemption information based on the second redemption request, the second redemption information instructing a second object identifier to redeem a virtual item corresponding to the second blind box identifier for a first object identifier, the second blind box identifier being a blind box identifier owned by the first object identifier, and transmits the second redemption information to a node device.

The second redemption request indicates that the second object identifier requests to redeem the virtual item for the first object identifier. The second redemption request carries the first object identifier as a consignor, the second object identifier as a consignee, and the second blind box identifier. The second terminal is a terminal logged by the second object identifier. In this embodiment of the present disclosure, an object indicated by the first object identifier can consign an object indicated by the second object identifier, so that the object indicated by the second object identifier can initiate, through the terminal, the process of redeeming the second blind box identifier owned by the first object identifier.

In a possible implementation, the generating second redemption information based on the second redemption request includes: combining the second object identifier as a requesting party, the first object identifier as a blind box owner, and the blind box identifier in the second redemption request to form the second redemption information.

In a possible implementation, if the server has blind box generation information and blind box obtaining information stored therein, the process of generating the second redemption information includes: verifying, by the server, the first object identifier and the second blind box identifier carried in the second redemption request based on the stored blind box generation information and blind box obtaining information, and generating the second redemption information based on the second redemption request in response to that the verification succeeds.

In this embodiment of the present disclosure, after receiving the second redemption request, the server performs the verification based on the stored blind box generation information and blind box obtaining information, and generates the second redemption information and transmits the second redemption information to the node device in response to that the verification succeeds, to prevent the server from transmitting the second redemption information to the node device in response to that the first object identifier does not own the second blind box identifier or the second blind box identifier is a fake identifier, thereby saving network resources.

The process of the server verifying the first object identifier and the second blind box identifier carried in the second redemption request is the same as operation 903 described below.

In a possible implementation, before generating the second redemption information, the server further performs identity verification. To be specific, the process of generating the second redemption information includes: transmitting, by the server, an identity verification notification to the second terminal in response to the second redemption request; obtaining, by the second terminal, identity verification information and transmitting the identity verification information to the server based on the identity verification notification; and generating, by the server, the second redemption information based on the second redemption request in response to that verification of the identity verification information succeeds.

In this embodiment of the present disclosure, before generating the second redemption information, the server performs identity verification to ensure that the second redemption request is initiated by the object indicated by the second object identifier through the second terminal, thereby ensuring security of blind box redemption.

902: The node device receives the second redemption information transmitted by the server.

This embodiment of the present disclosure is described by using the example in which the server transmits the second redemption information to the node device. However, in another embodiment, operations 901-902 described above do not need to be performed, and the node device receives the transmitted second redemption information in another manner.

903: The node device verifies the second redemption information based on blind box generation information and stored blind box obtaining information.

In this embodiment of the present disclosure, since the blind box identifier in the blind box generation information in a blockchain is a blind box identifier corresponding to a released blind box, and the blind box obtaining information stored in the blockchain can indicate an owner of a delivered blind box identifier, that is, an object identifier included in any blind box obtaining information is an owner of a blind box identifier included in the blind box obtaining information, the node device verifies the second redemption information based on the blind box generation information and the blind box obtaining information in the blockchain, to determine whether the second blind box identifier is a blind box identifier included in the blind box generation information, whether the first object identifier owns the second blind box identifier, and the like, thereby preventing fraud of the second blind box identifier and preventing redemption of a blind box indicated by the second blind box identifier but not owned by the first object identifier during blind box redemption for the first object identifier, thereby ensuring accuracy of subsequent blind box redemption.

904: The node device generates a block based on the second redemption information and stores the generated block in a blockchain in response to that the verification of the second redemption information succeeds.

The process of generating the block based on the second redemption information is the same as the process of generating the block based on the blind box generation information and the item configuration information described above, which is not described in detail herein.

In the solution provided in this embodiment of the present disclosure, an object can consign another object to redeem a blind box for the object. In the process in which the object redeems a blind box owned by another object, the node device verifies the second redemption information. In response to that the verification of the second redemption information succeeds, the block including the second redemption information is generated, and the generated block is stored in the blockchain, to achieve storage of the second redemption information in the blockchain and ensure accuracy of the data stored in the blockchain. Moreover, a redemption status of the released blind box may be traced based on the information stored in the blockchain, which can prevent fraud of blind boxes and ensure fairness of blind box transactions.

Based on the embodiment shown in FIG. 9 described above, in the embodiments of the present disclosure, the second redemption information may alternatively be verified in combination with stored redemption consignment information. The process of verifying the second redemption information includes: verifying the second redemption information based on the blind box generation information, the stored blind box obtaining information, and stored redemption consignment information, the redemption consignment information instructing a consignor to consign a consignee to redeem a virtual item corresponding to a blind box identifier, the blind box identifier being a blind box identifier owned by the consignor.

In this embodiment of the present disclosure, in the process in which the object consigns another object to redeem a blind box for the object, the node device stores redemption consignment information in the blockchain to indicate that the consignor consigns the consignee to redeem the virtual item corresponding to the blind box identifier, the redemption consignment information being used as a consignment credential. During the verification of the second redemption information, the second object identifier can initiate the process of redeeming the second blind box identifier only in response to that the blockchain has stored therein the redemption consignment information configured for indicating that the first object identifier consigns the second object identifier to redeem the second blind box identifier. Therefore, the second redemption information is further verified in combination with the stored redemption consignment information, to ensure accuracy of the verification and accuracy of subsequent blind box redemption.

In some embodiments, the redemption consignment information includes the object identifier as the consignor, the object identifier as the consignee, and the blind box identifier owned by the consignor.

In a possible implementation, operation 903 includes: verifying the second blind box identifier based on the blind box identifier in the blind box generation information; and querying the stored blind box obtaining information for blind box obtaining information including the first object identifier and the second blind box identifier; and querying the stored redemption consignment information for target redemption consignment information, the target redemption consignment information instructing the first object identifier to consign the second object identifier to redeem a virtual item, the virtual item corresponding to the second blind box identifier; and verify the virtual item based on item information associated with the second blind box identifier in the blind box generation information in response to that the blind box generation information includes the second blind box identifier.

In this embodiment of the present disclosure, the second blind box identifier is verified based on the blind box identifier in the blind box generation information, to determine whether the second blind box identifier is a blind box identifier included in the blind box generation information. The blockchain is queried for the blind box obtaining information including the first object identifier and the second blind box identifier to determine whether the first object identifier owns the second blind box identifier. The blockchain is queried to determine whether the target redemption consignment information configured for indicating that the first object identifier consigns the second object identifier to redeem the virtual item corresponding to the second blind box identifier exists, to determine whether the second object identifier has the right to redeem the second blind box identifier owned by the first object identifier. Moreover, in response to that the blind box generation information includes the second blind box identifier, the virtual item is further verified based on the item information associated with the second blind box identifier in the blind box generation information, to determine whether the virtual item indicated by the first redemption request is accurate, that is, determine whether the virtual item to be delivered to the first object identifier is sufficiently accurate.

In this embodiment of the present disclosure, verification is performed to determine whether the second blind box identifier is a blind box identifier included in the blind box generation information, whether the first object identifier owns the second blind box identifier, whether the second object identifier has the right to redeem the second blind box identifier owned by the first object identifier, and whether the virtual item to be delivered to the first object identifier is sufficiently accurate, so as to prevent fraud of the second blind box identifier, prevent the first object identifier without the second blind box identifier from redeeming the second blind box identifier, and prevent the second object identifier from redeeming the second blind box identifier without a redemption right, thereby ensuring accuracy of the verification and accuracy of subsequent blind box redemption.

In a possible implementation, a manner of determining whether the verification of the second redemption information succeeds includes: determining that the verification of the second redemption information succeeds in response to that the blind box generation information includes the second blind box identifier, the blind box obtaining information including the first object identifier and the second blind box identifier is obtained through query, the target redemption consignment information is obtained through query, and the item information associated with the second blind box identifier matches the virtual item; and determining that the verification of the second redemption information fails in response to that the blind box generation information does not include the second blind box identifier, or in response to that blind box obtaining information including the first object identifier and the second blind box identifier is not queried, or in response to that the target redemption consignment information is not queried, or in response to that the item information associated with the second blind box identifier does not match the virtual item.

In this embodiment of the present disclosure, in response to that the blind box generation information includes the second blind box identifier, the blind box obtaining information including the first object identifier and the second blind box identifier is obtained through query, the target redemption consignment information is obtained through query, and the item information associated with the second blind box identifier matches the virtual item, it indicates that the second blind box identifier is a blind box identifier corresponding to a released blind box, the first object identifier owns the second blind box identifier, the second object identifier has the right to redeem the second blind box identifier, and the virtual item to be delivered to the first object identifier is accurate, which indicates that the first object identifier can redeem the second blind box identifier and the virtual item corresponding to the second blind box identifier can be delivered to the first object identifier. Therefore, it is determined that the verification of the first redemption information succeeds.

In response to that the blind box generation information does not include the second blind box identifier, it indicates that the second blind box identifier is not the blind box identifier corresponding to the released blind box, that is, the second blind box identifier is a fake blind box identifier. In response to that the blind box obtaining information including both the first object identifier and the second blind box identifier is not obtained through query, it indicates that the first object identifier does not own the second blind box identifier, which indicates that the first object identifier cannot redeem the virtual item corresponding to the second blind box identifier. In response to that the target redemption consignment information is not obtained through query, it indicates that the second object identifier has no right to redeem the second blind box identifier owned by the first object identifier. In response to that the item information associated with the second blind box identifier does not match the virtual item, it indicates that the virtual item which is to be indicated to the first redemption information by the server is inaccurate. Therefore, it is determined the verification of the first redemption information fails.

In this embodiment of the present disclosure, it is determined whether the verification of the first redemption information succeeds depending on whether the blind box generation information includes the second blind box identifier and whether the blind box obtaining information including the first object identifier and the second blind box identifier is obtained through query, to prevent fraud of the second blind box identifier and prevent the first object identifier without the second blind box identifier from redeeming the virtual item corresponding to the second blind box identifier, thereby ensuring accuracy of the verification and accuracy of subsequent blind box redemptions.

In a possible implementation, the method further includes: transmitting, by the first terminal, a consignment request to the server, the consignment request indicating that the first object identifier consigns the second object identifier to redeem the virtual item corresponding to the second blind box identifier; generating, by the server, target redemption consignment information and transmitting the target redemption consignment information to the node device in response to the consignment request; and receiving, by the node device, the target redemption consignment information transmitted by the server; and verifying the target redemption consignment information based on the blind box generation information and the stored blind box obtaining information, and generating a block based on the target redemption consignment information and storing the generated block into the blockchain in response to that the verification of the target redemption consignment information succeeds.

In this embodiment of the present disclosure, the first terminal is a terminal logged by the first object identifier. The first terminal actively initiates a consignment process, so that the second object identifier has the right to redeem the second blind box identifier owned by the first object identifier. The node device stores the target consignment information in the blockchain, so that verification can be subsequently performed based on the stored target consignment information when the second object identifier initiates the redemption process, thereby ensuring accuracy of subsequent blind box redemption processes.

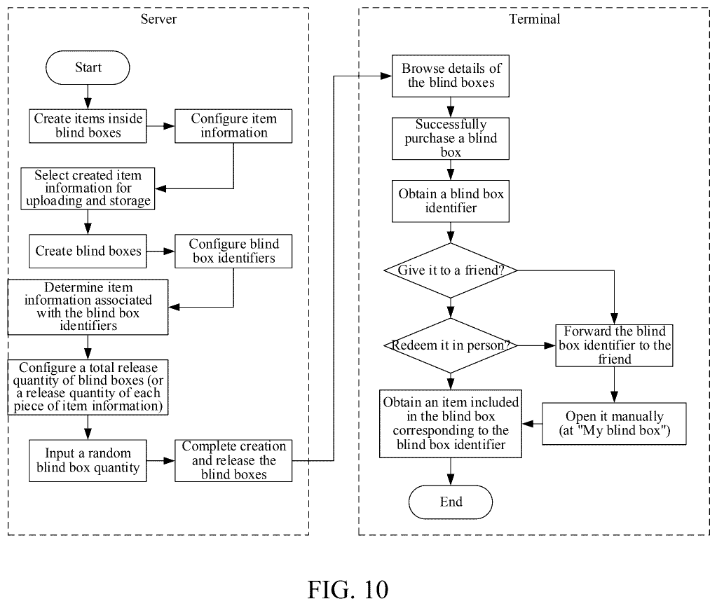

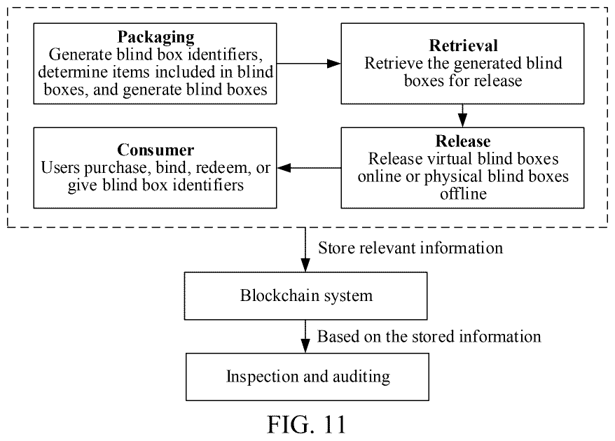

The embodiments shown in FIG. 4 to FIG. 9 above may be combined in different manners. For example, in combination with the embodiments shown in FIG. 4 to FIG. 9, as shown in FIG. 10 and FIG. 11, an embodiment of the present disclosure further provides a flowchart of a blockchain-based blind box management method. Taking a blind box being a virtual blind box as an example, the method includes the following operations:

Operation 1: Pre-configure item configuration information during generation of a batch of virtual blind boxes, the item configuration information indicating a generation status of the batch of virtual blind boxes; and officially announce the item configuration information to a user so that the user can obtain a status of items included in the batch of virtual blind boxes during purchase of the blind boxes.

Operation 2: Generate a plurality of blind box identifiers based on the item configuration information, upload the plurality of blind box identifiers to a blockchain for storage, associate each blind box identifier with item information to obtain blind box generation information, upload the blind box generation information to the blockchain for storage; and generate and release corresponding virtual blind boxes based on the blind box generation information.

Operation 3: A terminal displays a blind box display interface, the blind box display interface showing released virtual blind boxes; and the user selects and purchases virtual blind boxes through the virtual blind boxes shown in the terminal. During purchasing of the virtual blind boxes by the user, the server performs calculation through a blind box probability algorithm based on a current inventory of remaining virtual blind boxes, delivers blind box identifiers corresponding to the virtual blind boxes to the user, and performs a deduction from the inventory of remaining virtual blind boxes to prevent repeated delivery of virtual blind boxes. For example, among the generated virtual blind boxes, one virtual blind box includes a rare virtual item while the other virtual blind boxes include ordinary virtual items. In this case, during the delivery of the virtual blind boxes, if a user obtains the virtual blind box including the rare virtual item, the user or other users can obtain only virtual blind boxes including ordinary virtual items when obtaining virtual blind boxes from the remaining virtual blind boxes.

Operation 4: Obtain, in case that the user purchases any virtual blind box, a blind box identifier corresponding to the purchased virtual blind box, and store blind box obtaining information in the blockchain to record a status of purchasing the virtual blind box by the user.

Operation 5: Redeem, in response to that the user obtains the blind box identifier, an item corresponding to item information associated with the blind box identifier, i.e., realizing redemption of the item included in the obtained virtual blind box. Alternatively, the user may consign the obtained blind box identifier to a friend in response to that the user obtains the blind box identifier, and the friend redeems the item corresponding to the item information associated with the blind box identifier. In other words, a solution in which friends help open virtual blind boxes is achieved, thereby realizing the redemption of the item included in the obtained virtual blind box. Alternatively, the user may give the obtained blind box identifier to a friend when the user obtains the blind box identifier, so that the friend obtains the blind box identifier. Moreover, virtual blind box redemption information, giving information, and the like are stored in the blockchain, to record a redemption status of the virtual blind boxes or flow of the virtual blind boxes.

In this embodiment of the present disclosure, since relevant information of the flow of the blind boxes is stored in the blockchain records, subsequent tracing of the blind boxes can be achieved based on the information stored in the blockchain and the blind box identifiers, to determine whether a merchant producing the blind boxes have engaged in fraudulent activities, thereby ensuring fairness of blind box transactions.

According to the blockchain-based blind box management method provided in this embodiment of the present disclosure, a reliable database is collectively maintained in a decentralized and trustless manner, and all behaviors such as release, obtaining, and redemption of blind boxes are recorded in a tamper-proof manner. In this way, a more secure and controllable purchasing relationship between blind box enterprises and users is achieved, “information silos” between users and blind box enterprises can be resolved, and users' interests can be effectively protected.

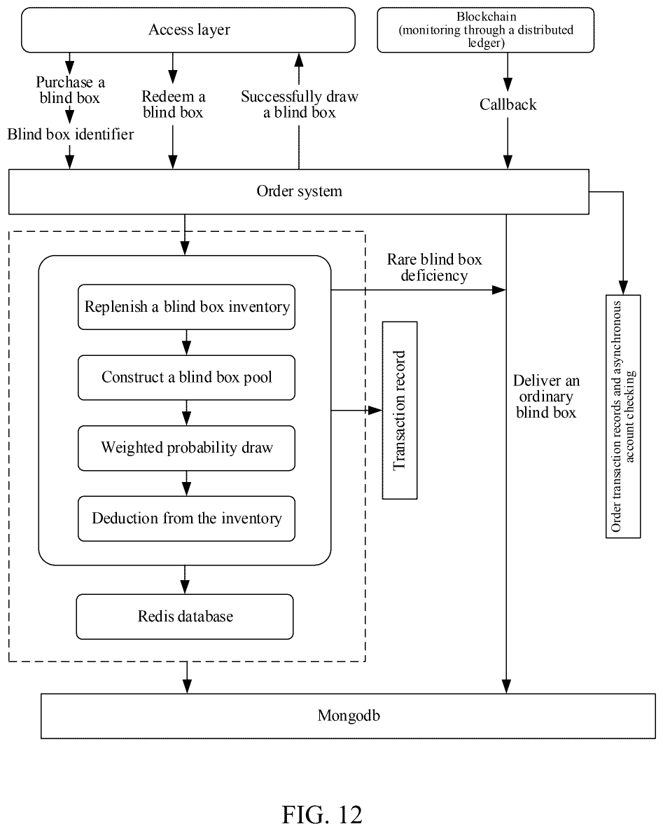

Based on the embodiments shown in FIG. 4 to FIG. 11, an embodiment of the present disclosure provides a social interaction-based blind box selling system. As shown in FIG. 12, the social interaction-based blind box selling system includes a server, a blockchain system, Redis (a database), and Mongodb (a database). The server includes an access layer and an order system. The order system is configured to provide functions such as blind box purchasing and blind box redemption for a terminal.

Taking a blind box being a virtual blind box as an example, before generating virtual blind boxes, the server pre-configures an inventory of virtual blind boxes, constructs a virtual blind box pool, and release blind boxes, so that a user can purchase the virtual blind boxes. Relevant information of the generated virtual blind boxes, such as a current inventory of remaining virtual blind boxes and the item information associated with a blind box identifier corresponding to each virtual blind box, is stored in Redis.

The user can interact with the order system through a terminal to purchase the blind boxes and obtain the blind box identifiers corresponding the blind boxes, and redeem the items included in the blind boxes. Moreover, during purchasing of the virtual blind boxes by the user, the server performs calculation through a blind box probability algorithm based on the current inventory of remaining virtual blind boxes, delivers blind box identifiers corresponding to the virtual blind boxes to the user, performs a deduction from the inventory of remaining virtual blind boxes, generates and stores a transaction record in Mongodb, and stores a delivery record of the virtual blind boxes in Mongodb.

Moreover, an order record may be stored through the order systems, which indicates a status of purchasing virtual blind boxes by each user. Through the order system, the order record may be checked to achieve asynchronous account checking, so as to check a selling status of the virtual blind boxes.

During selling of the blind boxes, the blockchain serves as a distributed, sharable, and tamper-proof ledger in which transactions, giving, and redemption of blind boxes can be recorded. Since the blockchain is a growing chain, the blockchain can only be added with records, and once confirmed, these records cannot be tampered with. Storing transaction records on the blockchain enables decentralization, eliminating a need of centralized control and achieving distributed storage as much as possible. Moreover, through a cryptographic mechanism, the blockchain can ensure that transactions cannot be denied or tampered with, while also protecting privacy of stored information.

According to the social interaction-based blind box selling system provided in this embodiment of the present disclosure, the tamper-proof characteristic of the blockchain facilitates copyright confirmation, transparency of the blockchain increases costs of malicious activities such as piracy, and automatic distribution of smart contracts reduces intermediary costs, which to a certain extent can improve the blind box market ecosystem.

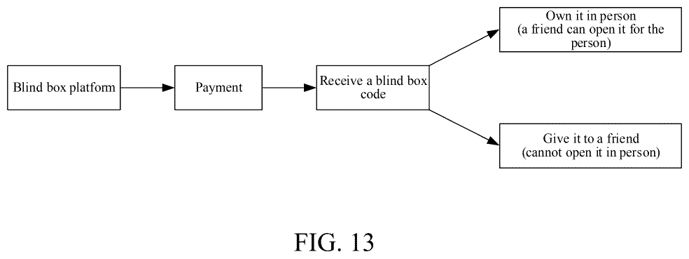

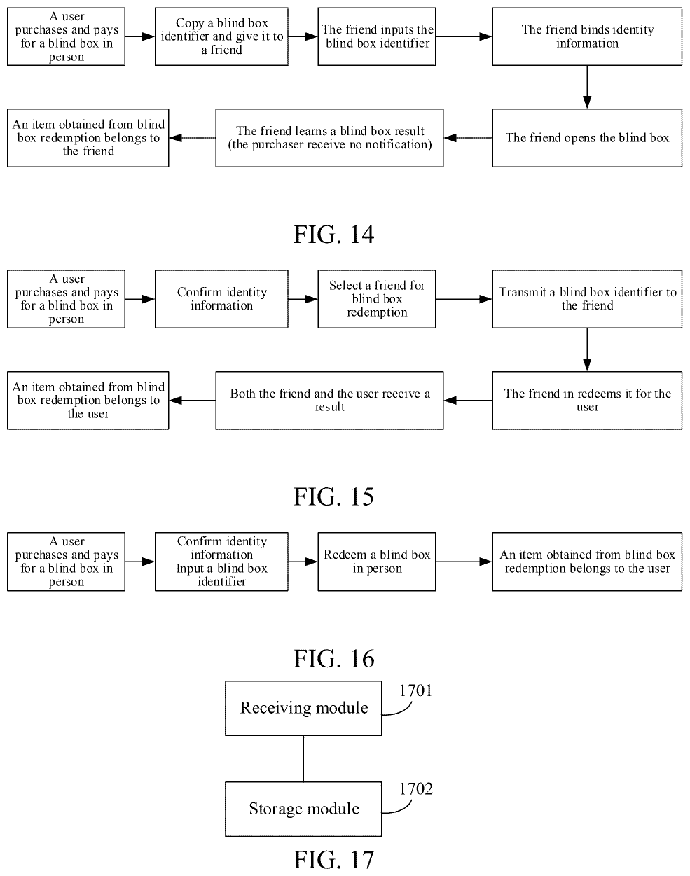

The blind box selling system provided in the foregoing embodiment may be applied to both an online virtual blind box selling scenario and an offline physical blind box selling scenario. As shown in FIG. 13 to FIG. 16, during purchasing of blind boxes by a user, binding between blind box identifiers and persons or giving blind box identifiers to friends is implemented, so that problems of nontransparent management and lack of social interaction in the blind box market are addressed, thereby expanding friend relationship chains and promoting a healthy market ecosystem.

In the online virtual blind box selling scenario, for users, a blind box purchasing process includes two options: giving away and keeping. The option of keeping includes two sub-options: a person redeems a virtual blind box in person or a friend redeems a virtual blind box for a person.

A user can purchase a virtual blind box through a terminal personally. Upon successful payment, the user owns the purchased virtual blind box, that is, owns a blind box identifier corresponding to the purchased virtual blind box. In this case, the user has both an ownership and a redemption right for the blind box identifier, as well as a right to consign the redemption right for the blind box identifier to a friend. Moreover, the user can bind the obtained blind box identifier with an object identifier corresponding to the user through the terminal, to bind the user with the obtained virtual blind box, to prevent the virtual blind box from being subsequently given to others. Moreover, in this process, relevant information is recorded in the blockchain to indicate the virtual blind box the user has purchased.

In response to that the user purchases a virtual blind box, the user can redeem the virtual blind box in person to obtain the virtual item included in the virtual blind box. Additionally, the user can seek assistance from others for redemption. To be specific, after obtaining the blind box identifier corresponding to the purchased virtual blind box, the user can transmit the blind box identifier to a friend through the terminal. For example, the user may transmit an online link carrying the blind box identifier to a terminal of the friend through the terminal, to instruct the friend to redeem the virtual blind box corresponding to the blind box identifier for the user. The friend logs into a blind box transaction platform through the terminal, inputs blind box code, and clicks/taps “Single-click/tap assistance to open”, to open the virtual blind box for the user. An ownership of the redeemed virtual item still belongs to the user, and the friend merely performs the redemption for the user. Moreover, both the user's terminal and the friend's terminal can receive a redemption result of the virtual blind box which indicates the virtual item included in the virtual blind box, so that both the user and the friend can know the redemption result of the virtual blind box.

Moreover, in response to that the user purchases a virtual blind box, the user can give the virtual blind box to a friend, that is, give a blind box identifier corresponding to the virtual blind box to a friend. The user copies the to-be-given blind box identifier through the terminal, selects “Give it to a friend”, and fills in information about the friend. If the friend agrees through the terminal and synchronously clicks/taps “Confirm” on the transaction platform, the giving process is successfully completed. Once the giving process is successfully completed, the user no longer retains the ownership of the virtual blind box, and cannot view or open the virtual blind box by inputting the blind box identifier again through the terminal. Instead, the friend of the user possesses the ownership and a redemption right for the virtual blind box, and can consign the redemption right to others for redeeming the virtual blind box by others.

In an offline physical blind box selling scenario, a user can purchase a physical blind box from a vending machine for blind boxes. The user scans a blind box identifier on a package of the physical blind box through a terminal to obtain the blind box identifier, and binds the blind box identifier to an identifier of the user, to indicate that the user has obtained an ownership of the physical blind box. The user can then open the physical blind box to obtain an included physical item. Additionally, the user can give the physical blind box to a friend, and the friend opens the physical blind box to obtain the physical item. Moreover, the user can purchase a blind box identifier corresponding to a physical blind box online, and give the blind box identifier to a friend. The friend inputs the blind box identifier at an offline selling point or an automatic vending machine and confirm accept the giving behavior, to obtain and redeem the physical blind box.

FIG. 17 is a schematic structural diagram of a blockchain-based blind box management apparatus according to an embodiment of the present disclosure. The apparatus is arranged in a node device in a blockchain system. As shown in FIG. 17, the apparatus includes: a receiving module 1701, configured to receive blind box generation information and corresponding item configuration information, the blind box generation information including a generated blind box identifier and item information associated with the blind box identifier, the item information associated with the blind box identifier indicating that a blind box corresponding to the blind box identifier is configured for packaging an item indicated by the item information, and the item configuration information including at least one of a release quantity of the item indicated by the item information or a proportion of the release quantity of the item to a release quantity of a plurality of items; and a storage module 1702, configured to: verify the blind box generation information and the item configuration information; and generate a block based on the blind box generation information and the item configuration information and store the generated block in a blockchain in response to that the blind box generation information is determined to match the item configuration information.

The receiving module 1701 further configured to receive blind box obtaining information, the blind box obtaining information including a first object identifier and a first blind box identifier, the first blind box identifier indicating a blind box obtained by the first object identifier.

The storage module 1702 is further configured to: verify the blind box obtaining information based on the blind box generation information and blind box delivery information, the blind box delivery information indicating a blind box delivery status corresponding to the blind box generation information; and generate a block based on the blind box obtaining information and store the generated block in the blockchain in response to that the verification of the blind box obtaining information succeeds.

In a possible implementation, the blind box delivery information includes a delivered blind box identifier; and the storage module 1702 is configured to verify the first blind box identifier based on the blind box identifier in the blind box generation information and the delivered blind box identifier.

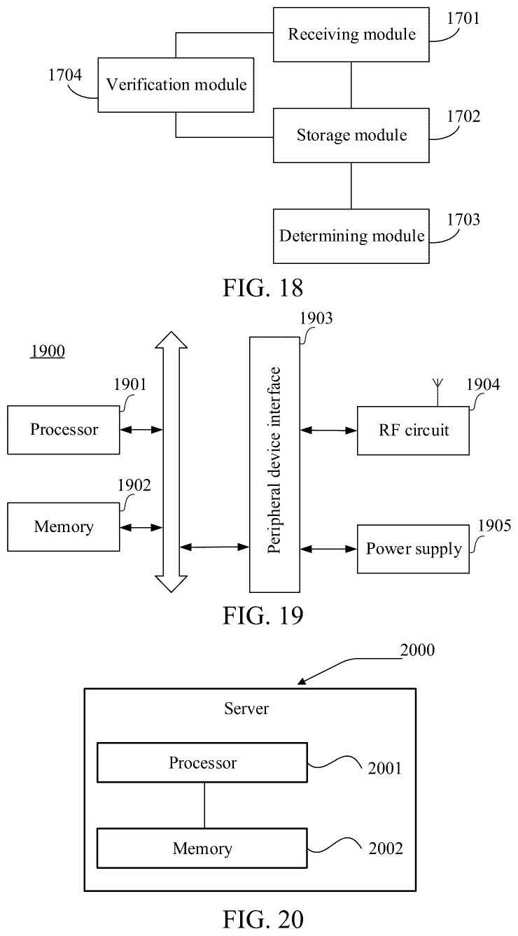

In another possible implementation, as shown in FIG. 18, the apparatus further includes a determining module 1703 configured to determine that the verification of the blind box obtaining information succeeds in response to that the blind box generation information includes the first blind box identifier and the delivered blind box identifier does not include the first blind box identifier. The determining module 1703 is further configured to determine that the verification of the blind box obtaining information fails in response to that the blind box generation information does not include the first blind box identifier or in response to that the delivered blind box identifier includes the first blind box identifier.

In another possible implementation, as shown in FIG. 18, the receiving module 1701 is further configured to receive blind box giving information, the blind box giving information indicating that the first object identifier gives a second blind box identifier to a second object identifier. The apparatus further includes a verification module 1704 configured to verify the blind box giving information based on the blind box generation information and stored blind box obtaining information. The storage module 1702 is further configured to generate a block based on the blind box giving information and store the generated block in the blockchain in response to that the verification of the blind box giving information succeeds.

In another possible implementation, the verification module 1704 is configured to: verify the second blind box identifier based on the blind box identifier in the blind box generation information; and query the stored blind box obtaining information for blind box obtaining information including the first object identifier and the second blind box identifier.

In another possible implementation, as shown in FIG. 18, the apparatus further includes a determining module 1703 configured to determine that the verification of the blind box giving information succeeds in response to that the blind box generation information includes the second blind box identifier and the blind box obtaining information including the first object identifier and the second blind box identifier is obtained through query. The determining module 1703 is further configured to determine that the verification of the blind box giving information fails in response to that the blind box generation information does not include the second blind box identifier or in response to that the blind box obtaining information including the first object identifier and the second blind box identifier is not obtained through query.

In another possible implementation, the receiving module 1701 is further configured to receive first redemption information, the first redemption information instructing the first object identifier to redeem a virtual item corresponding to a second blind box identifier, a virtual blind box corresponding to the second blind box identifier including the virtual item. The storage module 1702 is further configured to: verify the first redemption information based on the blind box generation information and stored blind box obtaining information, and generate a block based on the first redemption information and store the generated block in the blockchain in response to that the verification of the first redemption information succeeds.

In another possible implementation, the storage module 1702 is configured to: verify the second blind box identifier based on the blind box identifier in the blind box generation information; query the stored blind box obtaining information for blind box obtaining information including the first object identifier and the second blind box identifier; and verify the virtual item based on item information associated with the second blind box identifier in the blind box generation information in response to that the blind box generation information includes the second blind box identifier.

In another possible implementation, as shown in FIG. 18, the apparatus further includes a determining module 1703 configured to determine that the verification of the first redemption information succeeds in response to that the blind box generation information includes the second blind box identifier, the blind box obtaining information including the first object identifier and the second blind box identifier is obtained through query, and the item information associated with the second blind box identifier matches the virtual item.

The determining module 1703 is further configured to determine that the verification of the first redemption information fails in response to that the blind box generation information does not include the second blind box identifier, or in response to that the blind box obtaining information including the first object identifier and the second blind box identifier is not obtained through query, or in response to that the item information associated with the second blind box identifier does not match the virtual item.

In another possible implementation, the receiving module 1701 is further configured to receive second redemption information, the second redemption information instructing a second object identifier to redeem a virtual item for the first object identifier, the virtual item corresponding to a second blind box identifier, the second blind box identifier being a blind box identifier owned by the first object identifier.

The storage module 1702 is further configured to: verify the second redemption information based on the blind box generation information and stored blind box obtaining information, and generate a block based on the second redemption information and store the generated block in the blockchain in response to that the verification of the second redemption information succeeds.

In another possible implementation, the storage module 1702 is configured to verify the second redemption information based on the blind box generation information, the stored blind box obtaining information, and stored redemption consignment information, the redemption consignment information instructing a consignor to consign a consignee to redeem a virtual item corresponding to a blind box identifier, the blind box identifier being a blind box identifier owned by the consignor.

In another possible implementation, the storage module 1702 is configured to: verify the second blind box identifier based on the blind box identifier in the blind box generation information; query the stored blind box obtaining information for blind box obtaining information including the first object identifier and the second blind box identifier; and query the stored redemption consignment information for target redemption consignment information, the target redemption consignment information instructing the first object identifier to consign the second object identifier to redeem a virtual item, the virtual item corresponding to the second blind box identifier; and verify the virtual item based on item information associated with the second blind box identifier in the blind box generation information in response to that the blind box generation information includes the second blind box identifier.

In another possible implementation, as shown in FIG. 18, the apparatus further includes a determining module 1703 configured to determine that the verification of the second redemption information succeeds in response to that the blind box generation information includes the second blind box identifier, the blind box obtaining information including the first object identifier and the second blind box identifier is obtained through query, the target redemption consignment information is obtained through query, and the item information associated with the second blind box identifier matches the virtual item. The determining module 1703 is further configured to determine that the verification of the second redemption information fails in response to that the blind box generation information does not include the second blind box identifier, or in response to that blind box obtaining information including the first object identifier and the second blind box identifier is not obtained through query, or in response to that the target redemption consignment information is not obtained through query, or in response to that the item information associated with the second blind box identifier does not match the virtual item.

In another possible implementation, as shown in FIG. 18, the receiving module 1701 is further configured to receive the target redemption consignment information. The storage module 1702 is further configured to verify the target redemption consignment information based on the blind box generation information and the stored blind box obtaining information, and generate a block based on the target redemption consignment information and store the generated block in the blockchain in response to that the verification of the target redemption consignment information succeeds.

The blockchain-based blind box management apparatus provided in the foregoing embodiment is illustrated only with an example of division of the foregoing function modules. The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. In practical applications, the foregoing functions may be allocated to and completed by different function modules as required. In other words, the internal structure of the blockchain-based blind box management apparatus or a node device is divided into different function modules to complete all or some of the functions described above. Additionally, the blockchain-based blind box management apparatus provided in the foregoing embodiment belongs to the same concept as the embodiments of the blockchain-based blind box management method. For details of a specific implementation process thereof, refer to the method embodiments. The details are not described herein.

An embodiment of the present disclosure further provides a node device, including a processor and a memory, the memory having at least one computer program stored therein, the at least one computer program being loaded and executed by the processor to implement the operations performed in the blockchain-based blind box management method as described in the foregoing embodiments.

In some embodiments, the node device is provided as a terminal. FIG. 19 is a structural block diagram of a terminal 1900 according to an exemplary embodiment of the present disclosure. The terminal 1900 includes a processor 1901 and a memory 1902.

The processor 1901 may include one or more processing cores, for example, a 4-core processor or an 8-core processor. The processor 1901 may be implemented in at least one of the following hardware forms: a digital signal processor (DSP), a field-programmable gate array (FPGA), and a programmable logic array (PLA). The processor 1901 may also include a main processor and a coprocessor. The main processor is a processor configured to process data in an awake state, and is also referred to as a central processing unit (CPU). The coprocessor is a low-power processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an AI processor. The AI processor is configured to process computing operations related to machine learning.

The memory 1902 may include one or more computer-readable storage media. The computer-readable storage medium may be non-transient. The memory 1902 may further include a high-speed random access memory and a nonvolatile memory, for example, one or more disk storage devices or flash storage devices. In some embodiments, the non-transient computer-readable storage medium in the memory 1902 is configured to store at least one computer program. The at least one computer program is configured to be executed by the processor 1901 to implement the blockchain-based blind box management method provided in the method embodiments of the present disclosure.

In some embodiments, the terminal 1900 may further include a peripheral device interface 1903 and at least one peripheral device. The processor 1901, the memory 1902, and the peripheral device interface 1903 may be connected through a bus or a signal line. Each peripheral device may be connected to the peripheral device interface 1903 through a bus, a signal line, or a circuit board. Specifically, the peripheral device includes at least one of a radio frequency (RF) circuit 1904 and a power supply 1905.

The peripheral device interface 1903 may be configured to connect the at least one peripheral device related to input/output (I/O) to the processor 1901 and the memory 1902. In some embodiments, the processor 1901, the memory 1902, and the peripheral device interface 1903 are integrated on the same chip or circuit board. In some other embodiments, any one or two of the processor 1901, the memory 1902, and the peripheral device interface 1903 may be implemented on separate chips or circuit boards, which is not limited in this embodiment.

The RF circuit 1904 is configured to receive and transmit an RF signal, which is also referred to as an electromagnetic signal. The RF circuit 1904 communicates with a communication network and other communication devices through the electromagnetic signal. The RF circuit 1904 converts an electric signal into an electromagnetic signal for transmission, or converts a received electromagnetic signal into an electric signal. In some embodiments, the RF circuit 1904 includes an antenna system, an RF transceiver, one or more amplifiers, a tuner, an oscillator, a DSP, a codec chipset, a subscriber identity module card, and the like. The RF circuit 1904 may communicate with other terminals by using at least one wireless communication protocol. The wireless communication protocol includes but is not limited to the World Wide Web, a metropolitan area network, the Intranet, various generations of mobile communication networks (2G, 3G, 4G, and 5G), a wireless local area network, and/or a wireless fidelity (Wi-Fi) network. In some embodiments, the RF 1904 may further include a circuit related to near field communication (NFC), which is not limited in the present disclosure.

The power supply 1905 is configured to supply power to the components in the terminal 1900. The power supply 1905 may be an alternating current, a direct current, a disposable battery, or a rechargeable battery. When the power supply 1905 includes a rechargeable battery, the rechargeable battery may be a wired rechargeable battery or a wirelessly rechargeable battery. The wired rechargeable battery is a battery configured to be charged through a wired circuit, and the wirelessly rechargeable battery is a battery configured to be charged through a wireless coil. The rechargeable battery may be further configured to support a fast charging technology.

A person skilled in the art may understand that the structure shown in FIG. 19 does not constitute a limitation on the terminal 1900. The terminal may include more or fewer components than those shown in the figure, or some merged components, or different component arrangements.

In some embodiments, the node device is provided as a server. FIG. 20 is a schematic structural diagram of a server according to an embodiment of the present disclosure. A server 2000 may vary considerably in configuration or performance, and may include one or more CPUs 2001 and one or more memories 2002. The memory 2002 has at least one computer program stored therein, the at least one computer program being loaded and executed by the processor 2001 to implement the method provided in the foregoing method embodiments. Certainly, the server may further have components such as a wired or wireless network interface, a keyboard, and an I/O interface for input and output. The server may further include another component configured to implement a device function. Details are not described herein.

An embodiment of the present disclosure further provides a computer-readable storage medium, having at least one computer program stored therein, the at least one computer program being loaded and executed by a processor to implement the operations performed in the blockchain-based blind box management method in the foregoing embodiments.

An embodiment of the present disclosure further provides a computer program product, including a computer program, the computer program, when executed by a processor, implementing the operations performed in the blockchain-based blind box management method as described in the foregoing embodiments.

The foregoing descriptions are merely exemplary embodiments of the embodiments of the present disclosure, and are not intended to limit the embodiments of the present disclosure. Any modification, equivalent replacement, improvement, or the like made within the spirit and principle of the embodiments of the present disclosure shall fall within the protection scope of the present disclosure.

What is claimed is:

1. A blockchain-based blind box management method, performed by a node device in a blockchain system, the method comprising:
receiving blind box generation information and corresponding item configuration information, the blind box generation information comprising a generated blind box identifier and item information associated with the blind box identifier, the item information associated with the blind box identifier indicating that a blind box corresponding to the blind box identifier is configured for packaging an item indicated by the item information, and the item configuration information comprising at least one of a release quantity of the item indicated by the item information or a proportion of the release quantity of the item to a release quantity of a plurality of items;
verifying the blind box generation information and the item configuration information; generating a block based on the blind box generation information and the item configuration information and storing the generated block in a blockchain in response to that the blind box generation information is determined to match the item configuration information;
receiving blind box obtaining information, the blind box obtaining information comprising a first object identifier and a first blind box identifier, the first blind box identifier indicating a blind box obtained by the first object identifier;
performing a verification of the blind box obtaining information based on the blind box generation information and blind box delivery information, the blind box delivery information indicating a blind box delivery status corresponding to the blind box generation information; and
generating a block based on the blind box obtaining information and storing the generated block in the blockchain in response to that the verification of the blind box obtaining information succeeds.

2. The method according to claim 1, wherein the blind box delivery information comprises a delivered blind box identifier; and the performing a verification of the blind box obtaining information based on the blind box generation information and blind box delivery information comprises:
verifying the first blind box identifier based on the blind box identifier in the blind box generation information and the delivered blind box identifier.

3. The method according to claim 2, further comprising:
determining that the verification of the blind box obtaining information succeeds in response to that the blind box generation information comprises the first blind box identifier and the delivered blind box identifier does not comprise the first blind box identifier; and
determining that the verification of the blind box obtaining information fails in response to that the blind box generation information does not comprise the first blind box identifier or in response to that the delivered blind box identifier comprises the first blind box identifier.

4. The method according to claim 1, further comprising:
receiving blind box giving information, the blind box giving information indicating that the first object identifier gives a second blind box identifier to a second object identifier;
verifying the blind box giving information based on the blind box generation information and stored blind box obtaining information; and
generating a block based on the blind box giving information and storing the generated block in the blockchain in response to that the verification of the blind box giving information succeeds.

5. The method according to claim 4, wherein the verifying the blind box giving information based on the blind box generation information and stored blind box obtaining information comprises:
verifying the second blind box identifier based on the blind box identifier in the blind box generation information; and
querying the stored blind box obtaining information for blind box obtaining information comprising the first object identifier and the second blind box identifier.

6. The method according to claim 5, further comprising:
determining that the verification of the blind box giving information succeeds in response to that the blind box generation information comprises the second blind box identifier and the blind box obtaining information comprising the first object identifier and the second blind box identifier is obtained through query; and
determining that the verification of the blind box giving information fails in response to that the blind box generation information does not comprise the second blind box identifier or in response to that the blind box obtaining information comprising the first object identifier and the second blind box identifier is not obtained through query.

7. The method according to claim 1, further comprising:
receiving first redemption information, the first redemption information instructing the first object identifier to redeem a virtual item corresponding to a second blind box identifier, a virtual blind box corresponding to the second blind box identifier comprising the virtual item; and
verifying the first redemption information based on the blind box generation information and stored blind box obtaining information, and generating a block based on the first redemption information and storing the generated block in the blockchain in response to that the verification of the first redemption information succeeds.

8. The method according to claim 7, wherein the verifying the first redemption information based on the blind box generation information and stored blind box obtaining information comprises:
verifying the second blind box identifier based on the blind box identifier in the blind box generation information; and
querying the stored blind box obtaining information for blind box obtaining information comprising the first object identifier and the second blind box identifier; and
verifying the virtual item based on item information associated with the second blind box identifier in the blind box generation information in response to that the blind box generation information comprises the second blind box identifier.

9. The method according to claim 8, further comprising:
determining that the verification of the first redemption information succeeds in response to that the blind box generation information comprises the second blind box identifier, the blind box obtaining information comprising the first object identifier and the second blind box identifier is obtained through query, and the item information associated with the second blind box identifier matches the virtual item; and
determining that the verification of the first redemption information fails in response to that the blind box generation information does not comprise the second blind box identifier, or in response to that the blind box obtaining information comprising the first object identifier and the second blind box identifier is not obtained through query, or in response to that the item information associated with the second blind box identifier does not match the virtual item.

10. The method according to claim 1, further comprising:
receiving second redemption information, the second redemption information instructing a second object identifier to redeem a virtual item for the first object identifier, the virtual item corresponding to a second blind box identifier, the second blind box identifier being a blind box identifier owned by the first object identifier; and
verifying the second redemption information based on the blind box generation information and stored blind box obtaining information, and generating a block based on the second redemption information and storing the generated block in the blockchain in response to that the verification of the second redemption information succeeds.

11. The method according to claim 10, wherein the verifying the second redemption information based on the blind box generation information and stored blind box obtaining information comprises:
verifying the second redemption information based on the blind box generation information, the stored blind box obtaining information, and stored redemption consignment information, the redemption consignment information instructing a consignor to consign a consignee to redeem a virtual item corresponding to a blind box identifier, the blind box identifier being a blind box identifier owned by the consignor.

12. The method according to claim 11, wherein the verifying the second redemption information based on the blind box generation information, the stored blind box obtaining information, and stored redemption consignment information comprises:
verifying the second blind box identifier based on the blind box identifier in the blind box generation information; and
querying the stored blind box obtaining information for blind box obtaining information comprising the first object identifier and the second blind box identifier; and
querying the stored redemption consignment information for target redemption consignment information, the target redemption consignment information instructing the first object identifier to consign the second object identifier to redeem a virtual item, the virtual item corresponding to the second blind box identifier; and
verifying the virtual item based on item information associated with the second blind box identifier in the blind box generation information in response to that the blind box generation information comprises the second blind box identifier.

13. The method according to claim 12, further comprising:
determining that the verification of the second redemption information succeeds in response to that the blind box generation information comprises the second blind box identifier, the blind box obtaining information comprising the first object identifier and the second blind box identifier is obtained through query, the target redemption consignment information is obtained through query, and the item information associated with the second blind box identifier matches the virtual item; and
determining that the verification of the second redemption information fails in response to that the blind box generation information does not comprise the second blind box identifier, or in response to that blind box obtaining information comprising the first object identifier and the second blind box identifier is not obtained through query, or in response to that the target redemption consignment information is not obtained through query, or in response to that the item information associated with the second blind box identifier does not match the virtual item.

14. The method according to claim 12, wherein the method further comprises:
receiving the target redemption consignment information; and
verifying the target redemption consignment information based on the blind box generation information and the stored blind box obtaining information, and generating a block based on the target redemption consignment information and storing the generated block in the blockchain in response to that the verification of the target redemption consignment information succeeds.

15. Anode device, comprising a processor and a memory, the memory having at least one computer program stored therein, the at least one computer program being loaded and executed by the processor to implement:
receiving blind box generation information and corresponding item configuration information, the blind box generation information comprising a generated blind box identifier and item information associated with the blind box identifier, the item information associated with the blind box identifier indicating that a blind box corresponding to the blind box identifier is configured for packaging an item indicated by the item information, and the item configuration information comprising at least one of a release quantity of the item indicated by the item information or a proportion of the release quantity of the item to a release quantity of a plurality of items;
verifying the blind box generation information and the item configuration information; generating a block based on the blind box generation information and the item configuration information and storing the generated block in a blockchain in response to that the blind box generation information is determined to match the item configuration information;
receiving blind box obtaining information, the blind box obtaining information comprising a first object identifier and a first blind box identifier, the first blind box identifier indicating a blind box obtained by the first object identifier;
performing a verification of the blind box obtaining information based on the blind box generation information and blind box delivery information, the blind box delivery information indicating a blind box delivery status corresponding to the blind box generation information; and
generating a block based on the blind box obtaining information and storing the generated block in the blockchain in response to that the verification of the blind box obtaining information succeeds.

16. The node device according to claim 15, wherein the blind box delivery information comprises a delivered blind box identifier; and the performing a verification of the blind box obtaining information based on the blind box generation information and blind box delivery information comprises:
verifying the first blind box identifier based on the blind box identifier in the blind box generation information and the delivered blind box identifier.

17. The node device according to claim 16, wherein the processor is further configured to implement:
determining that the verification of the blind box obtaining information succeeds in response to that the blind box generation information comprises the first blind box identifier and the delivered blind box identifier does not comprise the first blind box identifier; and
determining that the verification of the blind box obtaining information fails in response to that the blind box generation information does not comprise the first blind box identifier or in response to that the delivered blind box identifier comprises the first blind box identifier.

18. The node device according to claim 15, wherein the processor is further configured to implement:
receiving blind box giving information, the blind box giving information indicating that the first object identifier gives a second blind box identifier to a second object identifier;
verifying the blind box giving information based on the blind box generation information and stored blind box obtaining information; and
generating a block based on the blind box giving information and storing the generated block in the blockchain in response to that the verification of the blind box giving information succeeds.

19. The node device according to claim 18, wherein the verifying the blind box giving information based on the blind box generation information and stored blind box obtaining information comprises:
verifying the second blind box identifier based on the blind box identifier in the blind box generation information; and
querying the stored blind box obtaining information for blind box obtaining information comprising the first object identifier and the second blind box identifier.

20. A non-transitory computer-readable storage medium, having at least one computer program stored therein, the at least one computer program being loaded and executed by a processor of a node device to implement:
receiving blind box generation information and corresponding item configuration information, the blind box generation information comprising a generated blind box identifier and item information associated with the blind box identifier, the item information associated with the blind box identifier indicating that a blind box corresponding to the blind box identifier is configured for packaging an item indicated by the item information, and the item configuration information comprising at least one of a release quantity of the item indicated by the item information or a proportion of the release quantity of the item to a release quantity of a plurality of items;
verifying the blind box generation information and the item configuration information; generating a block based on the blind box generation information and the item configuration information and storing the generated block in a blockchain in response to that the blind box generation information is determined to match the item configuration information;
receiving blind box obtaining information, the blind box obtaining information comprising a first object identifier and a first blind box identifier, the first blind box identifier indicating a blind box obtained by the first object identifier;
performing a verification of the blind box obtaining information based on the blind box generation information and blind box delivery information, the blind box delivery information indicating a blind box delivery status corresponding to the blind box generation information; and
generating a block based on the blind box obtaining information and storing the generated block in the blockchain in response to that the verification of the blind box obtaining information succeeds.
